(19) United States
(12) Patent Application Publication
(10) Pub. No.: US 2026/0127493 A1
(43) Pub. Date: May 7, 2026

(54) System and Methods of Training and Operation for a General Artificial Intelligence System for Data Generation

(71) Applicant: Joseph Juma, San Rafael, CA (US)

(72) Inventor: Joseph Juma, San Rafael, CA (US)

(21) Appl. No.: 19/289,558

(22) Filed: Aug. 4, 2025

Related U.S. Application Data
(60) Provisional application No. 63/680,062, filed on Aug. 6, 2024.

(51) Int. Cl. G06N 20/00

(52) U.S. Cl. CPC G06N 20/00

(57) ABSTRACT

An artificial intelligence system which, when trained on sample data, may be used to subsequently generate data of arbitrary structure, such as image, geometry, musical or decision logic structures, in a rule based and statistically abiding manner. A method for training the system on sample data is presented, and a method for employing the system for the generation of data when provided additional input data is presented. The produced data is generated by creating a set of valid values with assigned statistical probabilities and reduced to a single value by an arbitrary choosing function. The system and methods are particularly useful for rule-based generation in resource and training data constrained environments requiring rule-abiding dynamic generation solutions.

### RELATED PATENT APPLICATION AND INCORPORATION BY REFERENCE

This utility application claims the benefit of and priority of application 63/680,062 filed on Aug. 6, 2024, the contents of which are incorporated herein as if restated herein.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### (1) Field of the Invention

The disclosed embodiments relate to the field of artificial intelligence used with servers, processors, video graphic processors, specialized database structures and non-volatile computer readable media. More particularly, the embodiments relate to structures of artificial intelligence systems and process of training and employing an artificial intelligence system for the generation of data, such as but not limited to, image, voxel, musical, graph data, and dynamic decision making logics, such as those found in video games, procedural generation tools and simulation software.

### BRIEF SUMMARY OF THE INVENTION

Disclosed embodiments include systems and methods for training an artificial intelligence system on data to define relationships which may then be used to generate data, or perform dynamic decision making, in accordance with those relationships. One aspect of the invention provides a data structure for storing associations between input data and output statistical distributions. Another aspect of the invention is a process for extracting data from samples and inserting them into the associative system. In another aspect, a method for employing the associative data structure for rule-based generation of data is described. Additional aspects, applications and advantages of the invention will become apparent in view of the following description and associated figures.

### BRIEF DESCRIPTION OF THE DRAWINGS

FIG. 1 is a software architecture diagram of the structure of a Data Model object as it pertains to the invention.

FIG. 2 is a software architecture diagram of the structure of an AI object as it pertains to the invention.

FIG. 3 is a software architecture diagram of the structure of a Training Sample object as it pertains to the invention.

FIG. 4A is a flowchart of the general process of training the AI model.

FIG. 4B is a flowchart of the specific operations of the AI object when being provided a training sample.

FIG. 5A is a flowchart of the general process of employing the AI model for data generation.

FIG. 5B is a flowchart of the specific operations of the AI object, for the purpose of generating data.

FIG. 6 is a software architecture diagram of the structure of an AI Cache, an optional acceleration structure in the AI.

FIG. 7A is a flowchart of one embodiment of the Selection Function, referred to herein as Fuzzy Match.

FIG. 7B is a flowchart of one embodiment of the Selection Function, referred to herein as Distance Threshold.

FIG. 7C is a flowchart of one embodiment of the Selection Function, referred to herein as Distance Ordering.

FIG. 7D is a flowchart, continuing the description of the Distance Ordering (740) Selection function, referenced by FIG. 7C.

FIG. 7E is a flowchart, continuing the description of the Distance Ordering (740) Selection function, referenced by FIG. 7D.

FIG. 7F is a flowchart of one embodiment of the Selection Function, referred to herein as Distance Gradient.

FIG. 7G is a flowchart, continuing the description of the Distance Gradient (760) Selection function, referenced by FIG. 7F.

FIG. 7H is a flowchart, continuing the description of the Distance Gradient (760) Selection function, referenced by FIG. 7F.

FIG. 8A is a flowchart of one embodiment of the Collapse Function, referred to herein as Random Collapse.

FIG. 8B is a flowchart of one embodiment of the Collapse Function, referred to herein as Max Collapse.

FIG. 9A is an alteration of the Data Model object (100), for use in an embodiment of the invention in the application of image synthesis, referred to herein as an Image AI.

FIG. 9B is an alteration of the Training Model object (300), for use in an embodiment of the invention in the application of image synthesis, referred to herein as an Image AI.

FIG. 9C is a flowchart for the general steps for training the Image AI embodiment.

FIG. 9D is a flowchart of one embodiment of employing the Image AI embodiment.

FIG. 9E is an image with a sample being extracted for training.

FIG. 9F is an example of a damaged image.

FIG. 9G is the damaged image (970) after having been fixed by application of the Image AI.

FIG. 9H is an example of an arbitrary image.

FIG. 9I is an example of an image (980) after an application of the Image AI.

FIG. 10A is an alteration of the Data Model object (100), for use in an embodiment of the invention in the application of voxel spaces, referred to herein as a Voxel AI.

FIG. 10B is an alteration of the Training Model object (300), for use in an embodiment of the invention in the application of voxel spaces, referred to herein as a Voxel AI.

FIG. 10C is an example of a voxel space, and a sample being extracted from the voxel space for training.

FIG. 10D is a flowchart for the general steps for training the Voxel AI embodiment.

FIG. 10E is a flowchart of one embodiment of employing the system for operating on a voxel space.

FIG. 10F is an example of an arbitrary voxel space.

FIG. 10G is an example of a voxel space (1070) after an application of the Voxel AI.

FIG. 10H is an example of an arbitrary voxel space with missing regions.

FIG. 10I is an example of a voxel space (1080) after an application of the Voxel AI.

FIG. 11A is an alteration of the Data Model object (100), for use in an embodiment of the invention in the application of armature generation, referred to herein as an Armature AI.

FIG. 11B is an alteration of the Training Model object (300), for use in an embodiment of the invention in the application of armature generation, referred to herein as an Armature AI.

FIG. 11C is an example of an arbitrary armature rig.

FIG. 11D is a flowchart for the general steps for training the Armature AI embodiment.

FIG. 11E is an additional flowchart for the general steps for training the Armature AI embodiment, referenced by FIG. 11D.

FIG. 11F is a flowchart of one embodiment of employing an Armature AI system for generating parts of an armature.

FIG. 11G is an additional flowchart for the general steps for employing the Armature AI embodiment, referenced by FIG. 11F.

FIG. 11H is an example of a simple armature rig, comprising only a single bone.

FIG. 11I is an example of an armature rig generated from a simpler armature rig (1190).

FIG. 11J is an example of a simple armature rig, comprising of a single bone, with non-uniform scale.

FIG. 11K is an example of an armature rig generated from a non-uniform armature rig (1194).

FIG. 12A is an alteration of the Data Model object (100), for use in an embodiment of the invention in the application of node graph generation, referred to herein as a Graph AI.

FIG. 12B is an alteration of the Training Model object, for use in an embodiment of the invention in the application of nodegraph generation, referred to herein as a Graph AI.

FIG. 12C is a flowchart for the general steps for training the Music Graph AI embodiment.

FIG. 12D is a flowchart of one embodiment of employing a Graph AI system for generating parts of a musical notation graph.

FIG. 13A is an alteration of the Data Model object (100), for use in an embodiment of the invention in the application of dynamic decision systems, referred to herein as a Decision AI.

FIG. 13B is an alteration of the Training Sample object (300), for use in an embodiment of the invention in the application of dynamic decision systems, referred to herein as a Decision AI.

FIG. 13C is a flowchart for the general steps for training the Decision AI embodiment.

FIG. 13D is a flowchart of one embodiment of employing the system for generating dynamic logic from a Decision AI.

FIG. 13E is an alteration of the Data Model Object (100), for use in an embodiment of the invention in the application of multiple Decision AI systems, referred to herein as a Behavior AI.

FIG. 13F is a flowchart of one embodiment of employing a Behavior AI system for generating dynamic logic from one or more Decision AI.

### REFERENCE NUMERALS IN THE DRAWINGS

100 a general Data Model structure.
110 the data elements of a Data Model structure (100), which, in alterations of may comprise a plurality of arbitrary data values of arbitrary data types.
120 listing of functions of a Data Model structure (100), comprised of but limited to, a Fuzzy Equality Function (130), a Strict Equality Function (140), a Not Equality Function (150) and a Distance Function (160).
130 a Fuzzy Equality Function of the Data Model (100).
140 a Strict Equality Function of the Data Model (100).
150 a Not Equality Function of the Data Model (100).
160 a Distance Function of the Data Model (100).
200 an AI data structure.
210 an Associative Container inside of an AI data structure, with Data Models (100) as the key (220) and Weighted Tables as the value (230).
220 key Data Models in an AI Associative Container (210).
230 value Weighted Tables in an Associative Container (210).
240 a collection comprising of, but not limited to, functions in an AI structure (210).
250 a Selection Function in an AI structure (210).
260 a Collapse Function in an AI structure (210).
300 a Training Sample structure.
310 a Data Model (100) as part of a Training Sample (300) structure.
320 an Expected Value of arbitrary data type as part of a Training Sample (300) structure.
600 an AI Cache data structure, which may optionally be added to an AI data structure (200) to accelerate the operation of the AI.
610 an array data structure, containing a plurality of data elements, in the AI Cache (600).
612 a Weighted Table in the AI Cache (600) associated with a Data Model (614).
614 a Data Model in the AI Cache (600) associated with a Weighted Table (612).
620 a collection of functions for the AI Cache (600), comprising but not limited to a Strict Equality Operator (622).
622 a Strict Equality Operator function for the AI Cache (600).
900 a specialized embodiment of a Data Model structure (100) for operation on 4-channel, 32-bit, two-dimensional image data structures, referred to as an Image Data Model.
902 a collection of data elements (110) for the Image Data Model (900) comprising of, but not limited to, a plurality of pixels with specific identifiers (904).
904 a plurality of pixels with specific identifiers in an Image Data Model (900).
910 a plurality of functions based on the Data Model functions (120), specialized for operating on the Image Data Model (900) elements (902), comprising of but not limited to, a Fuzzy Equality Function (912) analogous to 130, a Strict Equality Function (914) analogous to 140, a Not Equality Function (916) analogous to 150, and a Distance Function (918) analogous to 160.
912 a Fuzzy Equality Function of the Data Model (900). 914 a Strict Equality Function of the Data Model (900).
916 a Not Equality Function of the Data Model (900).
918 a Distance Function of the Data Model (900).
930 a specialized embodiment of a Training Sample (300) for operation on two-dimensional image data structures, referred to as an Image Training Sample.
932 an Image Data Model (900) specialization of the Data Model in a Training Sample (310), in an Image Training Sample (930).
934 a specialization of an Expected Value (320) for an Image Training Sample (930) comprised of a color data value.
960 an image with a plurality of pixels (904) for an Image Data Model (900) being extracted from it.
970 an example image with missing pixels.
972 a column of missing or damaged pixels.
974 an example image (970) after an Image AI is employed to replace the damaged pixels (972).
980 an example image.
982 an example image (980) after an Image AI is employed to replace each pixel, which may or may not result in a different pixel in each location.
1000 a specialized embodiment of a Data Model structure (100) for operation on a three-dimensional voxel space data structure, referred to as a Voxel Data Model.
1002 a collection of data elements (110) for the Voxel Data Model (1000) comprising of, but not limited to, a plurality of voxels with specific identifiers (1004).
1004 a plurality of voxels with specific identifiers in a Voxel Data Model (1000).
1010 a plurality of functions based on the Data Model functions (120), specialized for operating on the Image Data Model (1000) elements (1002), comprising of but not limited to, a Fuzzy Equality Function (1012) analogous to 130, a Strict Equality Function (1014) analogous to 140, a Not Equality Function (1016) analogous to 150, and a Distance Function (1018) analogous to 160.
1012 a Fuzzy Equality Function of the Voxel Data Model (1000).
1014 a Strict Equality Function of the Voxel Data Model (1000). 1016 a Not Equality Function of the Voxel Data Model (1000).
1018 a Distance Function of the Voxel Data Model (1000).
1030 a specialized embodiment of a Training Sample (300) for operation on three-dimensional voxel data structures, referred to as a Voxel Training Sample.
1032 a Voxel Data Model (1000) specialization of the Data Model in a Training Sample (310), in a Voxel Training Sample (1030).
1034 a specialization of an Expected Value (320) for a Voxel Training Sample (1030) comprised of a voxel value.
1040 an arbitrary voxel space, with a plurality of voxels (1041) for a Voxel Data Model (1000) being extracted from it.
1041 an extracted plurality of 26 voxels, being extracted into a Voxel Data Model (1000).
1070 an example voxel space.
1071 the previous voxel space (1070) after a Voxel AI was employed on it to replace voxel values according to training.
1080 an example voxel space with a missing region of voxels.
1081 the previous voxel space (1080) after a Voxel AI was employed to replace the missing voxels.
1100 a specialized embodiment of a Data Model structure (100) for operation on 3D armature systems, denoted an Armature Data Model.
1102 a collection of data elements (110) for the Armature Data Model (1100) comprising, but not limited to, a bone identifier value (1104).
1104 a bone identifier value.
1110 a plurality of functions based on the Data Model functions (120), specialized for operating on the Armature Data Model (1100) elements (1102), comprising of but not limited to, a Fuzzy Equality Function (1112) analogous to 130, a Strict Equality Function (1114) analogous to 140, a Not Equality Function (1116) analogous to 150, and a Distance Function (1118) analogous to 160.
1112 a Fuzzy Equality Function of the Armature Data Model (1100).
1114 a Strict Equality Function of the Armature Data Model (1100).
1116 a Not Equality Function of the Armature Data Model (1100).
1118 a Distance Function of the Armature Data Model (1100).
1130 a specialized embodiment of a Training Sample (300) for training an AI structure (200) for operation on 3D armature systems.
1132 an Armature Data Model (1100) specialization of the Data Model in a Training Sample (310), in an Armature Training Sample (1130).
1134 a specialization of an Expected Value (320) for an Armature Training Sample (1130) comprised of a bone object.
1140 an example armature rig, comprising of three bones, with the identifiers of humerus (1141), ulna (1142) and hand (1143).
1141 a bone in an example armature rig (1140), with a bone identifier of “humerus”, scale of (1,1,1), rotation of (−15,0,0), with one child bone, denoted the “ulna” (1142).
1142 a bone in an example armature rig (1140), with a bone identifier of “ulna”, scale of (0.8, 0.8, 0.8), relative rotation of (30, 0, 0), a parent bone with identifier “humerus” (1141) and with one child bone, denoted the “hand” (1143).
1143 a bone in an example armature rig (1140), with a bone identifier of “hand”, scale of (0.4, 0.4, 0.4), relative rotation of (30, 0, 0), a parent bone with identifier “ulna” (1142) and with no children bones.
1190 an example armature rig comprised of a single bone, with a bone identifier of “humerus” (1192).
1192 a bone in an example armature rig (1190), with identifier “humerus”.
1193 an example armature rig which has been generated from a prior armature rig (1190) after the application of an Armature AI, comprised of 3 bones.
1194 an example armature rig comprised of a single bone, with a bone identifier of “humerus” (1195), which has a scale of (1.5, 1, 1), referred to as “non-uniform” due to the first component of the scale vector being different from the remaining components.
1195 a bone in an example armature rig (1194), with identifier “humerus”.
1196 an example armature rig which has been generated from a prior armature rig (1194) after the application of an Armature AI, comprised of 3 bones.
1200 a specialized embodiment of a Data Model structure (100) for operation on a topological graph structure with nodes containing arbitrary data, referred to as a Graph Data Model.
1202 a collection of data elements (110) for the Graph Data Model (1200) comprising of, but not limited to, a collection of one or more contextual values (1204) and a collection of one or more node reference values (1206).
1204 a plurality of contextual values for use in a Graph Data Model (1200).
1206 a plurality of topological graph node object references for use in a Graph Data Model (1200).
1210 a plurality of functions based on the Data Model functions (120), specialized for operating on the Graph Data Model (1200) elements (1202), comprising of but not limited to, a Fuzzy Equality Function (1212) analogous to 130, a Strict Equality Function (1214) analogous to 140, a Not Equality Function (1216) analogous to 150, and a Distance Function (1218) analogous to 160.
1212 a Fuzzy Equality Function of the Graph Data Model (1200).
1214 a Strict Equality Function of the Graph Data Model (1200).
1216 a Not Equality Function of the Graph Data Model (1200).
1218 a Distance Function of the Graph Data Model (1200).
1230 a specialized embodiment of a Training Sample (300) for operation on a topological graph structure with nodes containing arbitrary data, referred to as a Graph Training Sample.
1232 a Graph Data Model (1200) specialization of the Data Model in a Training Sample (310), in a Graph Training Sample (1230).
1234 a specialization of an Expected Value (320) for a Graph Training Sample (1030) comprised of a node structure containing arbitrary data values.
1300 a specialized embodiment of a Data Model structure (100) for dynamic decision making systems, denoted a Decision Data Model.
1302 a collection of data elements (110) for the Decision Data Model (1300) comprising, but not limited to, an arbitrary state object (1304).
1304 a state object with specific identifiers in a Decision Data Model (1300).
1310 a plurality of functions based on the Data Model functions (120), specialized for operating on the Decision Data Model (1300) elements (1302), comprising of but not limited to, a Fuzzy Equality Function (1312) analogous to 130, a Strict Equality Function (1314) analogous to 140, a Not Equality Function (1316) analogous to 150, and a Distance Function (1318) analogous to 160.
1312 a Fuzzy Equality Function of the Decision Data Model (1300).
1314 a Strict Equality Function of the Decision Data Model (1300).
1316 a Not Equality Function of the Decision Data Model (1300).
1318 a Distance Function of the Decision Data Model (1300).
1330 a specialized embodiment of a Training Sample (300) for training an AI structure (200) to for dynamic decision making systems.
1332 a Decision Data Model (1300) specialization of the Data Model in a Training Sample (310), in a Decision Training Sample (1330).
1334 a specialization of an Expected Value (320) for a Decision Training Sample (1330) comprised of a Decision object.
1360 a specialized embodiment of a finite state automata for employing multiple Decision Data Models (1300) in sophisticated dynamic decision making systems, denoted as a Behavioral Data Model.
1362 a collection of data elements (110) for the Behavioral Data Model (1360).
1364 a plurality of Decision Data Model (1300) objects.
1366 a software reference to a specific Decision Data Model (1300) indicating the Decision Data Model (1300) currently considered as the state of the Behavioral Data Model (1360).
1370 a single function denoted as Execute Function (1372) for operation on a Behavioral Data Model (1360) in an iterative manner.
1372 the Execute Function of a Behavioral Data Model (1360).

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification, and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

Although the following detailed description contains many specifics for the purposes of illustration, anyone of ordinary skill in the Art will appreciate that many variations and alterations to the following details are within the scope of the invention. Accordingly, the following embodiments of the invention are set forth without any loss of generality to, and without imposing limitations upon, the claimed invention.

A generative rule-based system will have a plurality of possible variables which dictate the likelihood of a given output variable. A weighted table may be employed in modeling the possible valid generated output values, given the value of the variables the generation is dependent upon, and prior samples which illustrate examples of the system's rules in action. In this weighted table, each possible output value is associated with input conditions and has a statistical weight value associated with it as well.

The collection of dependent variable configurations may then be associated with a particular weighted table which has a series of possible output values associated with their respective probability, or probability-like value, of arising should those system parameters be met. In addition, if the data structure which stores the dependent variable configuration possess both a function which loosely associates it with other states, denoted a Fuzzy Equality Function, and a function which strictly associates it only with other identical states, denoted a Strict Equality Function, then reasonably similar dependent variable configurations may have their collective output sets combined such that, a given value in both will have its respective probability values added together in the newly combined weighted table. The system which performs the associative storage of probabilistic outcomes in fuzzy association with dependent variable models may replicate similar behavior as other artificial intelligence systems such as neural networks, thereby affording it parity in being denoted as an artificial intelligence method. Although a Weighted Table is by no means a novelty, the application of fuzzy equality on a multi-variable dependent-variables model for aggregating a weighted table of composite probabilities is a distinct form of novelty. In addition, one or more of the embodiments of specific functions for asserting similarity between two dependent variable collections, denoted Selection Functions, and functions for selecting a value from the resulting Weighted Table, denoted Collapse Functions, may be considered novel as to their application in this structure.

A system may be employed which efficiently associates input data models of arbitrary structure, so long as certain key constraints are met, with desired output values of arbitrary and general type. For the sake of the invention, the term Weighted Table will refer to any data structure which stores a plurality of elements comprising a value of arbitrary data type, and a weight value. The associated weight value may be, but is not limited to, a frequency, probability value or value which indicates some magnitude which may be employed to create a weighted random selection which anyone of sufficient competency in the art will be able to produce. For the sake of the invention, the term Associative Container, will refer to any arbitrary data structure which holds a plurality of elements comprising an index value of arbitrary data type, denoted the Key, and an associated value of arbitrary data type, denoted the Associated Value.

It is common in the prior art for practitioners to design software such that it may be adapted through trivial efforts to a wide range of circumstances through a variety of techniques. One such technique allows a practitioner to make reference to an existing software object, comprising of, but not limited to, a collection of one or more values, denoted as Elements, and software procedures, denoted as Methods, which may then be altered in some manner, such as, but not limited to, adding or replacing Elements in the original object and adding or replacing Methods in the original object, commonly referred to in the Art as “Inheritance and Polymorphism”. Additionally, a technique may be employed where a software object, denoted herein as the External Software Object, is constructed such that it contains another software object, denoted herein as the Internal Software Object, facilitating the usage of the Internal Software Object in conjunction with the specific details of the External Software Object, to produce software behaviors based on the core logics of the Internal Software Object, commonly referred to in the Art as “Object Composition”. An additional technique may be employed where a software object is produced in the textual, source format, whereby certain aspects of the textual representation, commonly referred to as “Template Arguments”, may be trivially changed, which, in conjunction with an automated system, such as, but not limited to, what are commonly referred to in the Art as a compiler, transpiler or templating system, may be employed to generate software in textual source, or binary formats whereby the alteration of Template Arguments may result in alterations to the original software object and logics thereof, commonly referred to in the Art as “Templates” or “Template Specializations”. An additional technique may be employed where, during the operation of a specific software application, a copy of a Software Object is produced in the computer system's memory, referred to as a Prototype, which may be arbitrarily altered, such as but not limited to, replacing, adding or removing Elements, and replacing, adding or removing Methods, such that the logic of the Prototype may arbitrarily specialize and differentiation itself from the original Software Object, commonly referred to in the Art as “Prototype Inheritance”.

It is also common in prior art to employ a collection of software, furnished to a developer in either binary or source code forms, commonly referred to in the Art as a “Software Library”, under a legal agreement, at times, but not always, in return for some manner of compensation, to facilitate the development of software with aspects which one developer may be unable to produce for some arbitrary reasons. It is a common practice to develop Software Libraries, such that it is comprised of various Software Objects, procedures, denoted as functions, processes and algorithms which may be trivially adapted by the employing practitioners to a specific use case by employing techniques such as, but not limited to, Inheritance and Polymorphism, Object Composition, Prototype Inheritance and Templates. As such, it is common practice for practitioners in the prior art to develop Software Libraries with these techniques in mind, and seek to produce specific, material and discrete embodiments of Software Objects, functions and systems which may be easily adapted to a large variety of specific applications.

For example, a Software Object common in the prior art, commonly referred to by those in the Art as a “Dynamic Array”, comprising a plurality of other Software Objects or values, organized in computer memory in a contiguous and serial format, which may allocate additional memory resources, according to a plurality of different algorithms, such as, but not limited to, extending the number of allocated regions of computer memory by a value calculated as an exponent of 2, or extending the number of allocated regions of computer memory by a fixed amount, as the number of containing elements expands according to the Software Objects usage in additional systems, may be employed in a large variety of manners, and with any arbitrary type of data, such as but not limited to, numbers, textual sequences, boolean values comprising a value of either “true” or “false”, color information comprising, but not limited to, 32-bit unsigned integer representations of 4-channel color information, and numerous other additional forms of data, through the employment of above mentioned techniques of Inheritance and Polymorphism, Templates and Prototype Inheritance.

The following embodiments are with respect to specific, material software embodiments of the Invention, such as, but not limited to, those which may be produced in a specific software application, or Software Library, with the intent and design to be easily altered for adaptability to a wide variety of applications through the employment of the above mentioned techniques of Inheritance and Polymorphism, Prototype Inheritance, Templates and Object Composition. As such any generality in the embodiments herein may be considered as specific, material implementations of Software Objects and procedures for use in a Software Library, which may then be later employed through the aforementioned techniques in more specific applications.

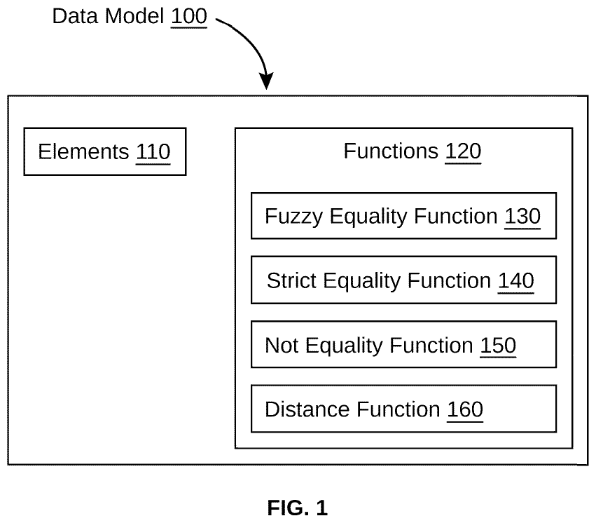

Referring to FIG. 1, the architecture of a software Data Model (100), for use in the invention is shown. A Data Model (100) comprises a collection of one or more Elements (110) comprised of an identifier and value of arbitrary data types, and a collection of Functions (120) comprised of but not limited to a Fuzzy Equality Function (130), a Strict Equality Function (140), a Not Equality Function (150) and a Distance Function (160). The Fuzzy Equality Function (130) is a function which takes in at minimum two objects fitting the layout of a Data Model (100), or a Data Model embodiment, optionally additional variables, and returns a boolean value of “true” or “false” if the two input Data Model objects are considered similar but not completely equal, referred to herein as Fuzzy Equality. The Strict Equality Function (140) is a function which takes in at least two objects fitting the layout of a Data Model (100), or Data Model embodiment, and returns a boolean value of “true”, if the two Data Model objects are considered identical, and “false” otherwise.

The Not Equality Function (150) is a function which takes in at least two objects fitting the layout of a Data Model (100), or Data Model embodiment, and returns a boolean value of “true” or “false” which would be either the opposite or logical complement of the Fuzzy Equality Function (130) if provided the same values. The Distance Function (160) is a function which takes in at least two objects fitting the layout of a Data Model (100) and returns a value of arbitrary data type indicating some notion analogous to distance between the two input Data Models.

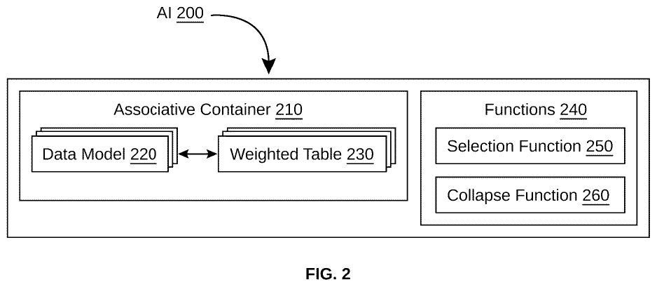

Referring to FIG. 2, the architecture of an AI (200) software system is shown. An AI (200) comprises an Associative Container (210) containing a plurality of elements, where the Key (220) is a structure fitting the architecture of a Data Model (100) structure, and the Associated Value is a Weighted Table (230) with values of one or more of the expected generated data types, and a plurality of Functions (240), containing but not limited to a Selection Function (250) and a Collapse Function (260). A Selection Function (250) is an arbitrary function which may be adjusted to alter the exact behavior of the AI, but which takes in, but is not limited to, an input object of the Data Model (100) type expected by the AI, or alternatively any arbitrary data structure meeting the requirements of a Data Model (100) structure, and the Associative Container (210) of the AI, and returns a Weighted Table with values of one or more of the expected output types. The Collapse Function (260) is an arbitrary function which may be adjusted to alter the exact behavior of the AI, but which takes in, but is not limited to, an input Weighted Table object, and returns a value of an expected output data type.

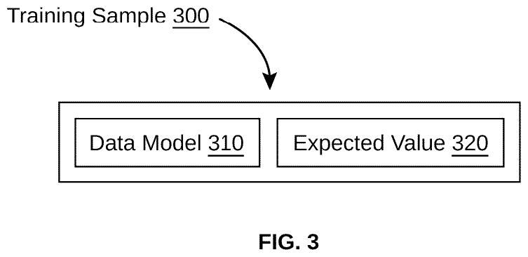

Referring to FIG. 3, the architecture of a Training Sample (300) is shown. A Training Sample (300) comprises but is not limited to an object fitting the architecture of a Data Model (310), and an Expected Value (320) of an arbitrary data type. The Training Sample (300) is employed in the process of training an AI (200), by providing it with associated Data Models (310) and Expected Values (320) for the desired output. In the following description, an unsigned integer weight value indicating frequency will be employed.

Additionally, the language in the following section will describe a bare minimum embodiment of the system and methods of the invention, which although contain many specifics, anyone of ordinary skill in the Art will appreciate that many variations and alterations to the following details may be made which are trivial and therefore may be considered within the Scope of the invention. Accordingly, the following embodiments of the invention are set forth without any loss of generality to, and without imposing limitations upon, the claimed invention.

The process of training an AI (200) first requires that a specialization of the Data Model (100) is made with defined Elements (110), Fuzzy Equality Function (130), Strict Equality Function (140) and Distance Function (160), and one or more expected arbitrary output data types are known.

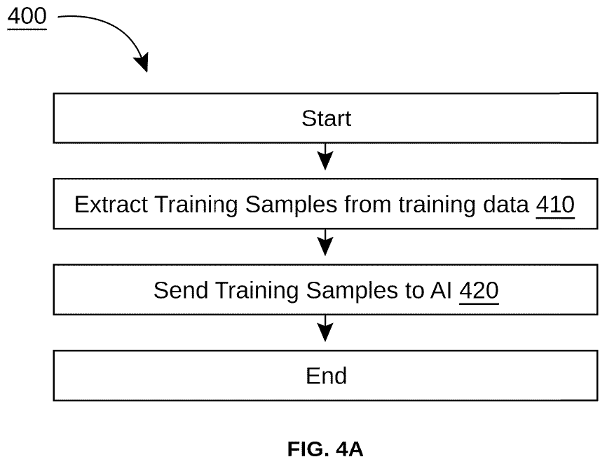

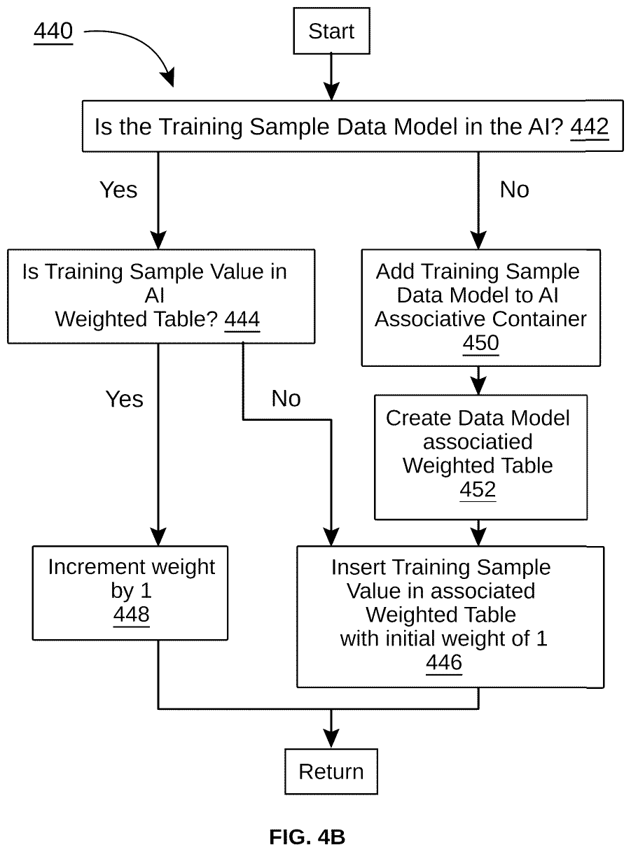

Referring to FIG. 4A, an overview of the training process is shown. Given some form of training data, a Training Sample is created (410) by extracting data from the training data to fill the Elements (110) of a Data Model (100), and set the Expected Value (320). One or more training samples is prepared, which are then passed to the AI (420) for insertion into the Associative Container (210).

Referring to FIG. 4B, the insertion process (440) begins with checking if the Data Model (310) inside of the Training Sample (300) returns “true” when the Strict Equality Function (140) of the Data Model (310) is provided the input Data Model (310) and each existing Associative Container (210) Key Data Model (442). If this process returns “true”, the Associated Data is returned and checked for the Expected Value (320) (444). If the Expected Value is found, the weight associated with it is incremented by 1, or an arbitrary unit value, dependent upon the notion of weight chosen (448), before the operation completes. If, at 444, the Training Sample Value is not found in the Weighted Table, it is added to the table with an initial default weight (446) of 1, before the operation completes.

If, at 442, the Training Sample Data Model is not found in the AI, it is added as a Key to the Associative Container (210) (450) followed by creating a new, empty Weighted Table (452), and inserting the Training Sample's Value into the newly created Weighted Table with a default weight value (446) before the operation completes. Once the AI has been trained it may be employed in generation and decision-making processes.

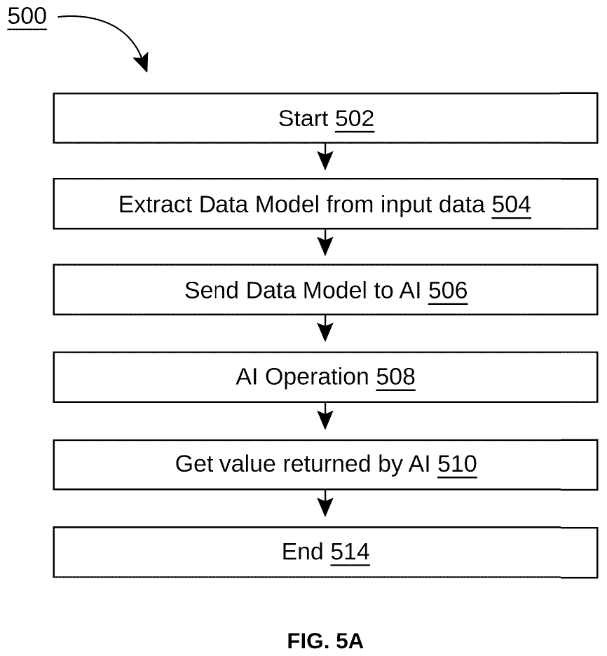

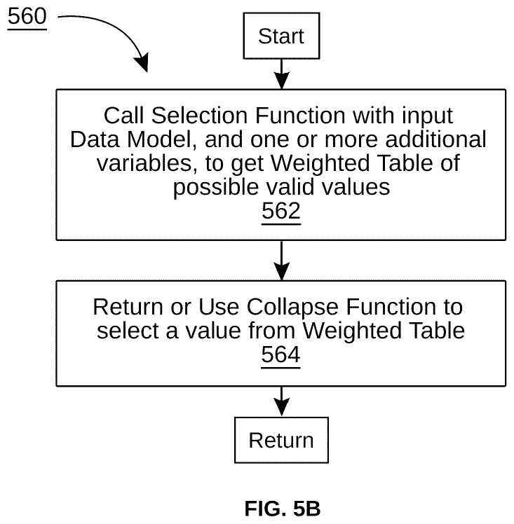

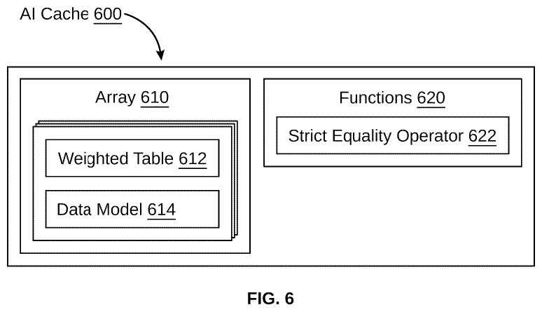

Referring to FIG. 5A, an overview of the usage process is shown. An arbitrary method is employed to extract a Data Model (100) which either possesses compatible functions (120) or fits the exact structure of those stored in the AI (220) (504). This Data Model (100) is provided to the AI (506) which begins the AI's operation (508).

Referring to FIG. 5B, the internal logic of the AI operation (560) is shown. The Data Model (100) is provided to the Selection Function (250) specified by the AI, either by design or during the method in the case of one or more selection functions, in addition to the contents of the Associative Container (210) for the process of generating a Weighted Table of valid results (562).

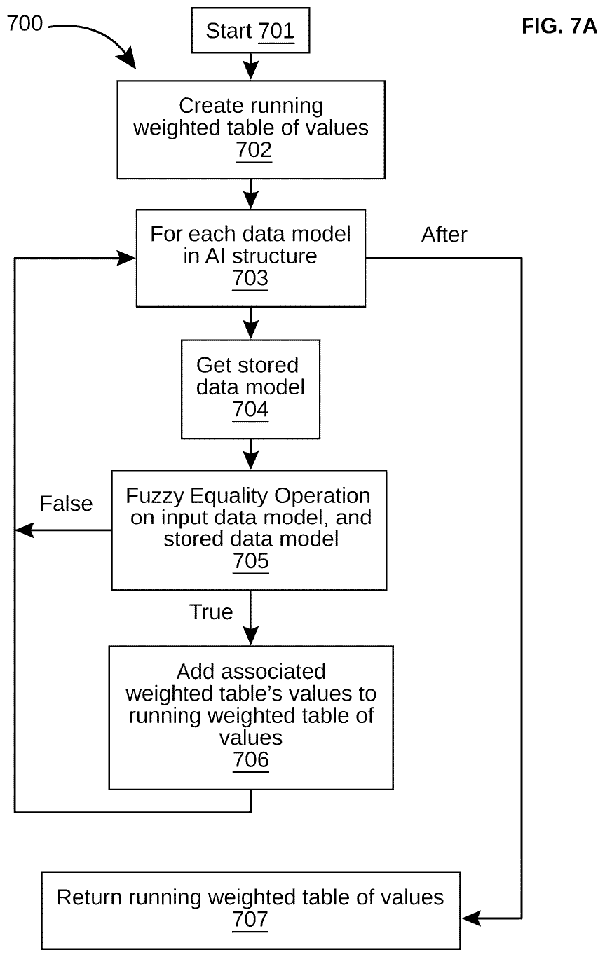

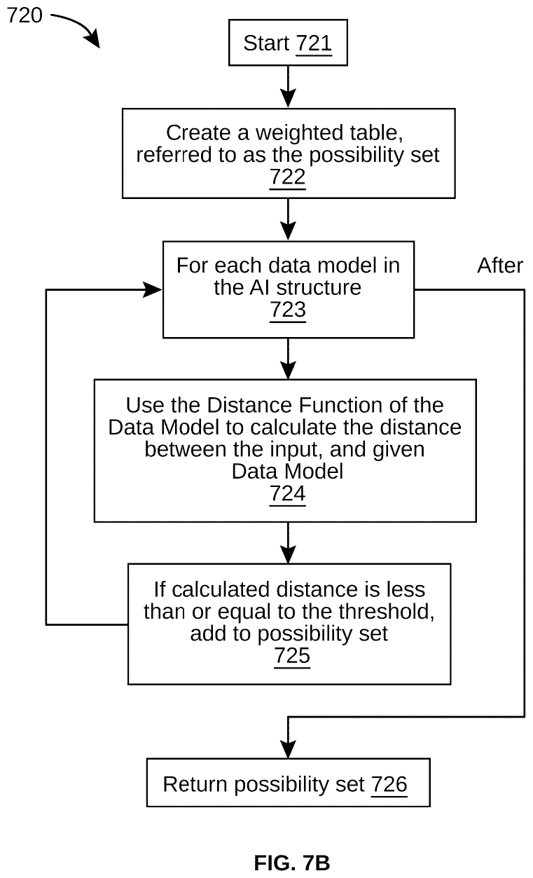

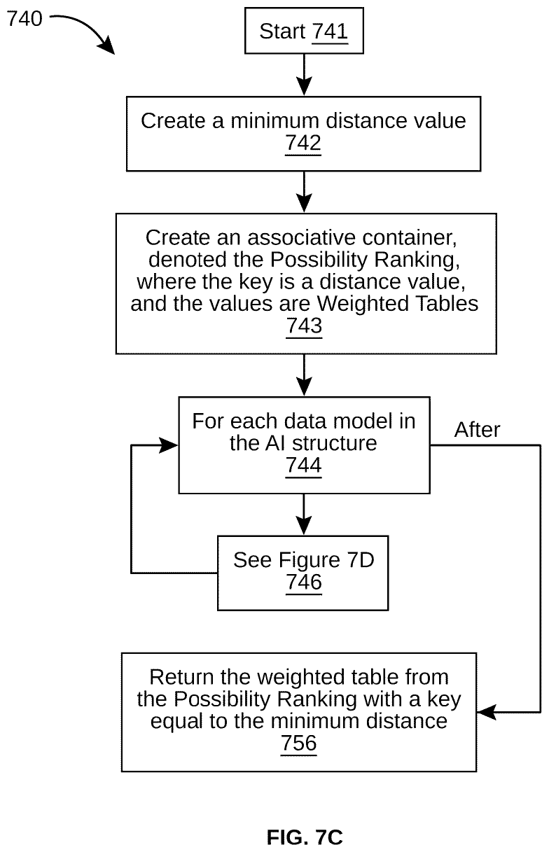

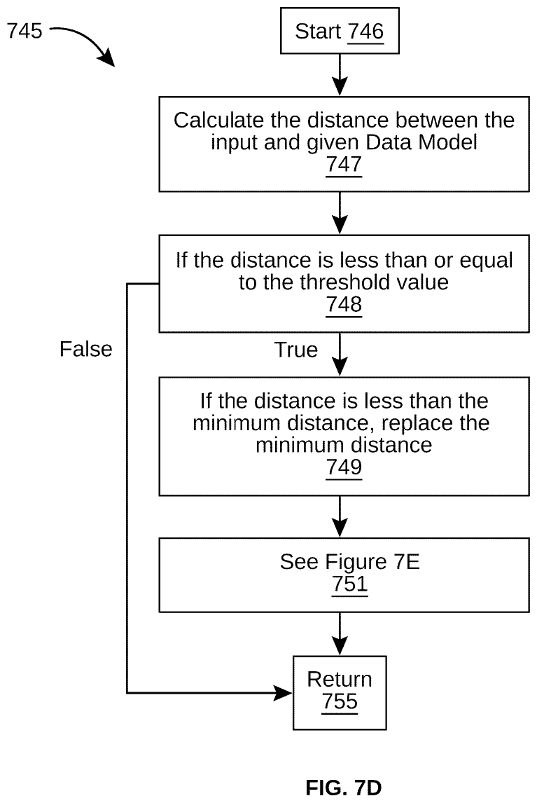

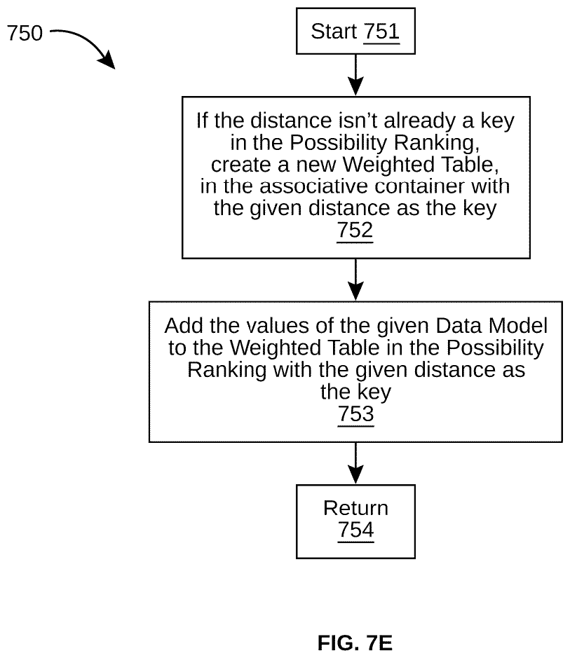

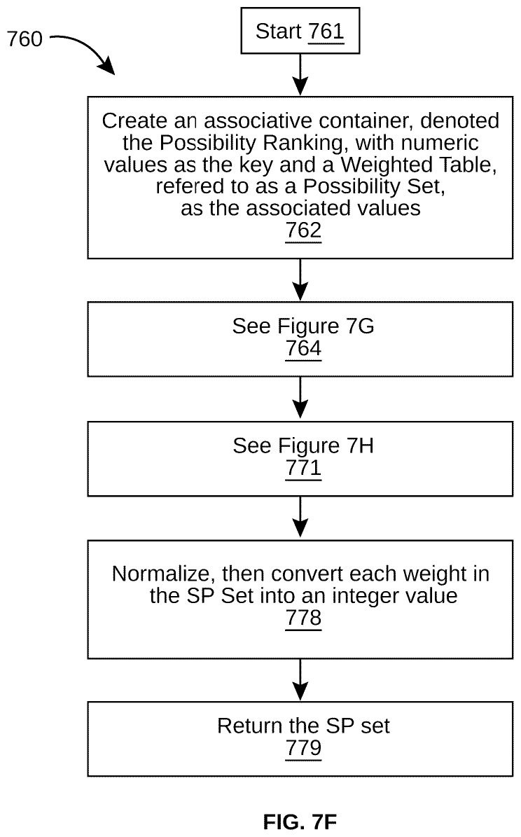

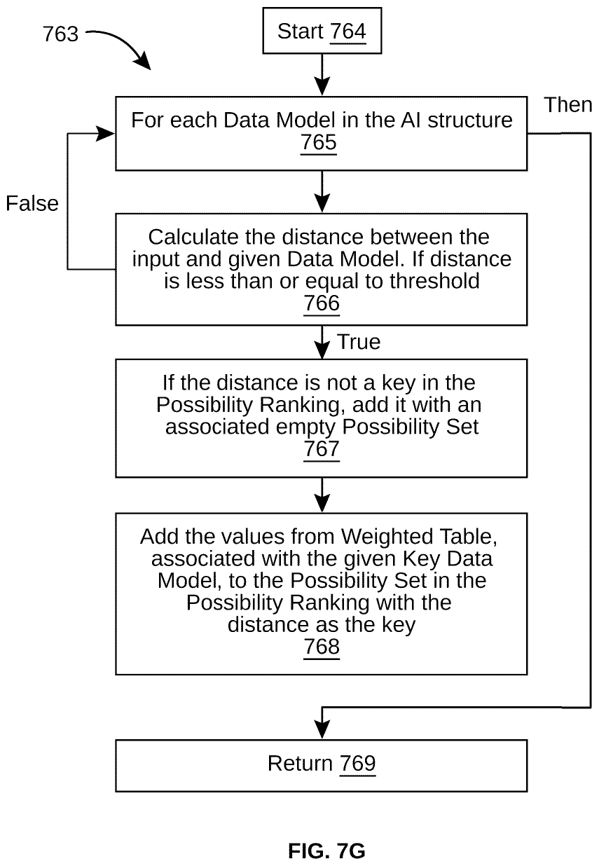

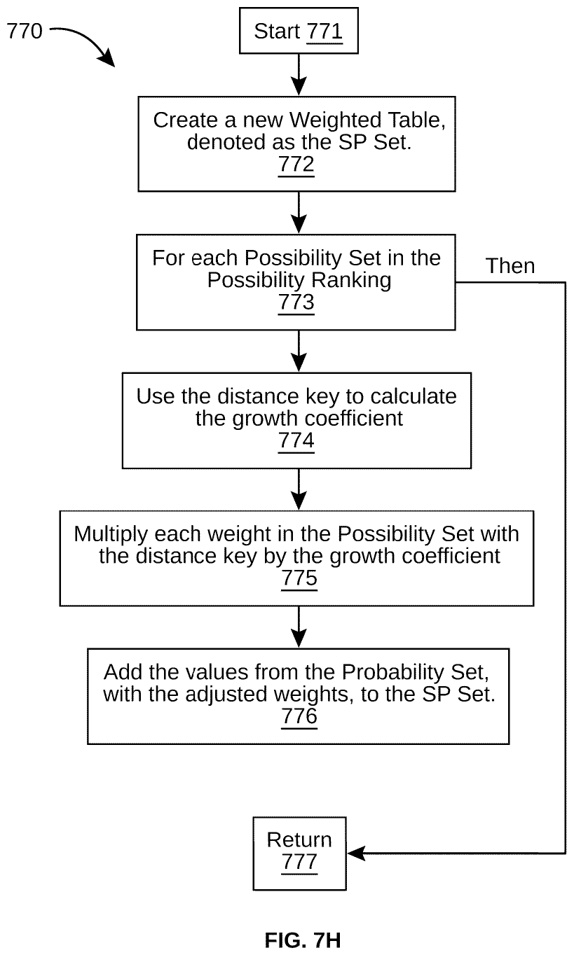

Referring now to FIG. 7A, a flow-graph illustrating the logic of an embodiment of a Selection Function (250), denoted as “Fuzzy Match” (700) is illustrated. First a new Weighted Table, denoted the Possibility Table, is constructed to hold the valid values (702). Then, for each of the plurality of Keys in the AI object's Associative Container (210) the Fuzzy Equality Function (130) is used to compare the Key to the input Data Model (705). If the Key and input Data Model Fuzzy Equality returns true, the associated Weighted Table values are added to the Possibility Table (706). In the event that a value already exists in a Weighted Table, including but not limited to the Possibility Table, any attempt to insert it again will merely combine the weight of the corresponding instances of that value.

If the Key and input Data Model Fuzzy Equality returns false, nothing is done (705). Once all Keys have been iterated through, the constructed Possibility Table is returned (707).

Referring now to FIG. 5B, the Possibility Table is then either returned by the AI, or passed to a Collapse Function which employs arbitrary logic to extract a single value from the Weighted Table which is then returned by the AI (564).

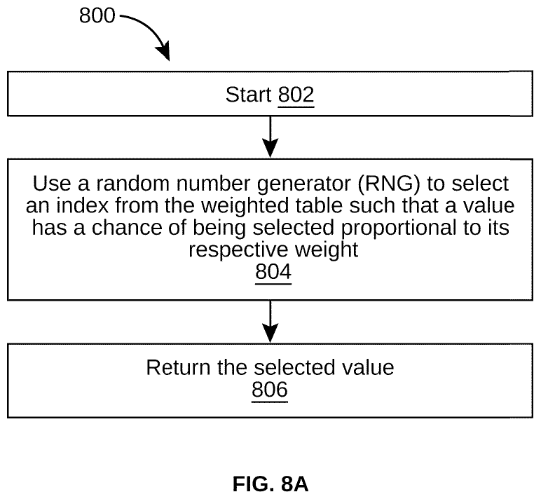

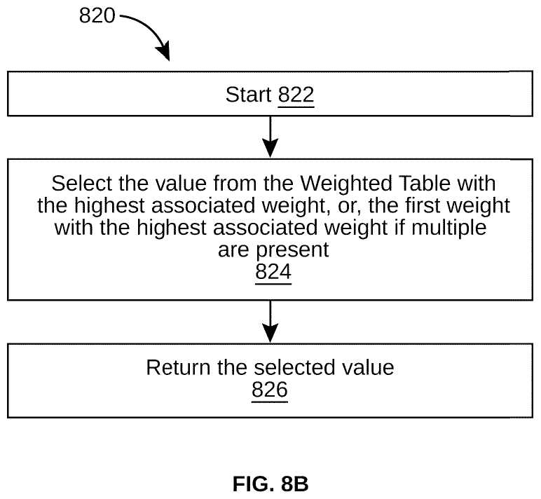

Referring now to FIG. 8A, a flow-graph illustrating the logic of an embodiment of a Collapse Function (260), denoted as Random Collapse (800) is illustrated. First a random number generator is employed to generate a number between 0 and the size of the Possibility Set minus 1, such that a value has a chance of its index being generated proportional to its weight (804). Then the value at the index of the randomly generated number is returned (806).

Referring to FIG. 5A, the value is returned by the AI (510) for usage in some arbitrary manner, completing the operation of the AI (514).

Anyone of ordinary skill in the art will appreciate that many variations and alterations of this process may be easily produced that are within the scope of the invention by altering key aspects of the system and methods described in the invention. Accordingly, the following embodiments are set forth without any loss of generality to, and without imposing limitations upon, the claimed invention.

By adjusting the Selection Function (250) or the Collapse Function (260) employed in an AI, it is possible to adjust the behavior of the AI system. For example, a Selection Function (250) which employs the Distance Function (160) of a corresponding Data Model (100) may be used.

Referring to FIG. 7B, a flow-graph illustrating the logic of an embodiment of a Selection Function (250) employing distance, denoted as “Distance Threshold” (720) is illustrated. The intent of this type of Selection Function (250) is to allow Data Models (100) to generate output values which are associated with other Data Models (100) within some limit of similarity as defined by the Distance Function (160). The following is a specific embodiment of this intent. First a new Weighted Table, denoted the Possibility Set, is constructed to hold the valid values (722). Then, for each of the plurality of Keys in the AI object's Associative Container (210) the Distance Function (160) is used to calculate a distance between the input Data Model, and the Key Data Model (724). If the calculated distance is less than or equal to a threshold value provided to the function, the values in the Weighted Table (230) associated with the Key Data Model (220) used to calculate the distance are added to the Possibility Set (725). Once all of the keys have been iterated through, the Possibility Set is returned by the function (726).

Referring to FIG. 7C, a flow-graph illustrating the logic of an embodiment of a Selection Function (250) employing distance, denoted as “Distance Ordering” (740) is illustrated. The intent of this type of Selection Function (250) is to allow Data Models (100) provided as input, which are not found in the AI structure (200) to return possible values associated with the closest matching Data Models (100). The following is a specific embodiment of this intent. First, a minimum distance value is created (742), and an Associative Container, denoted the Possibility Ranking, where each Key is a distance value, and each Value is a Weighted Table of values is created (743). Then, for each of the plurality of Keys in the AI object's Associative Container (210) a flow of logic (745) is carried out (746).

Referring now to FIG. 7D, a flow-graph illustrating logic employed by the embodiment of a Selection Function (250) denoted as, “Distance Ordering” (740) is shown (745). The distance of the input Data Model, and the given Key Data Model is calculated using the Distance Function (160) for the given Data Model (100) (747). If the distance is less than or equal to a given threshold value, then the algorithm proceeds to the following steps (748). The distance is compared to the minimum distance and, if the distance is less than the minimum distance, then the minimum distance is replaced with the distance value (749).

Referring now to FIG. 7E, a flow-graph illustrating logic employed by the embodiment of a Selection Function (250), denoted as “Distance Ordering” (740) is shown (750). If the given distance value is not already a Key in the Possibility Ranking, a new Weighted Table Value is created with the given distance as the associated Key (752). Then the values in the Weighted Table associated with the given Key Data Model are added to the Weighted Table in the Possibility Ranking with the given Key distance (753).

Referring now to FIG. 7D, when the additional logic (750) completes, or if the distance is greater than the given threshold, this logic section returns (755) to the looping logic which evoked it (744).

Referring now to FIG. 7C, once all of the keys (220) in the AI Structure (200) have been iterated through, the Weighted Table in the Possibility Ranking with an associated Key equal to the minimum distance is returned by the function (756).

Referring to FIG. 7F, a flow-graph illustrating the logic of an embodiment of a Selection Function (250) employing distance, denoted as “Distance Gradient” (760) is illustrated. The intent of this type of Selection Function (250) is to allow the selection of any value within a given limit of similarity to be selected, not unlike “Distance Threshold” (720), but where values associated with Data Models (100) which are less similar are of some proportionally lower statistical weight. The following is a specific embodiment of this intent. First, an associated container, denoted as the Possibility Ranking, with numeric values as the Key, and a Weighted Table, referred to as a Possibility Set, as the associated Value, is created (762).

Referring now to FIG. 7G, a flow-graph illustrating logic employed by the embodiment of a Selection Function (250), denoted as “Distance Gradient” (760) is shown (763). For each Key Data Model (220) in the AI (200), the distance between the input Data Model and given Key Data Model is calculated, and if less than or equal to the given threshold value then the algorithm proceeds to the following steps (766). If the calculated distance is not already a key in the Possibility Ranking, a new, empty Possibility Set is created and added to the Possibility Ranking with the calculated distance as the associated key (767). Then the values from the Weighted Table associated with the given Key Data Model are added to the Possibility Set with the calculated distance as the associated key (768). After each Key Data Model (220) has been iterated over, the algorithm proceeds to the next series of steps (769).

Referring now to FIG. 7H, a flow-graph illustrating logic employed by the embodiment of a Selection Function (250), denoted as “Distance Gradient” (760) is shown (763). A new Weighted Table, denoted as the SP Set, is created (772). For each Possibility Set in the Possibility Ranking (773), the distance key is used to calculate a growth coefficient according to the following formula (774), where g denotes a given growth factor and n is the distance key value.

$$coefficient ( g , n ) = {g}^{- n}$$

Given the growth formula, multiply each weight associated that is associated with each value in the Possibility Set associated with each key in the Possibility Ranking to get a new weight (775). Then add the values from the Probability Set, with their adjusted weights, to the SP Set. Once each Possibility Set is iterated through, return the SP Set (777).

Referring now to FIG. 7F. Normalize each weight in the SP Set by summing all the weights associated with values in the SP Set to calculate the total weight, then divide each weight by the total weight. Once the SP Set weights have been normalized, convert each weight from a real number into a relatively approximate integer using the following formula.

$$ω = w ( {g}^{- δ} ) σ$$

Where W denotes a given weight, ω denotes the same weight in integer form, and σ denotes a scaling coefficient calculated from the following formula,

$$σ = {10}^{⌈ \vert \frac{log ( v )}{log ( 10 )} \vert ⌉}$$

Where ν denotes the smallest of the weight values in the SP Set prior to conversion (778). Once the SP Set has been normalized, return the SP Set as the Possibility Set for this function (779).

An additional embodiment of a Selection Function (250) employing distance, denoted as “Distance Greater Than Threshold” is described herein, which is a modification of the general “Distance Threshold” (720) Selection Function (250). The intent of this type of Selection Function (250) is to allow Data Models (100) to generate output values which are associated with other Data Models (100) beyond or at a specified threshold of similarity as defined by the Distance Function (160). The following is a specific embodiment of this intent. First a new Weighted Table, denoted the Possibility Set, is constructed to hold the valid values. Then, for each of the plurality of Keys in the AI object's Associative Container (210) the Distance Function (160) is used to calculate a distance between the input Data Model, and the Key Data Model. If the calculated distance is greater than or equal to a threshold value provided to the function, the values in the Weighted Table (230) associated with the Key Data Model (220) used to calculate the distance are added to the Possibility Set. Once all of the keys have been iterated through, the Possibility Set is returned by the function.

An additional embodiment of a Selection Function (250) employing distance, denoted as “Distance Within Range” is described herein, which is a modification of the general “Distance Threshold” (720) Selection Function (250). The intent of this type of Selection Function (250) is to allow Data Models (100) to generate output values which are associated with other Data Models (100) within specified range of similarity as defined by the Distance Function (160). The following is a specific embodiment of this intent. First a new Weighted Table, denoted the Possibility Set, is constructed to hold the valid values. Then, for each of the plurality of Keys in the AI object's Associative Container (210) the Distance Function (160) is used to calculate a distance between the input Data Model, and the Key Data Model. If the calculated distance is greater than or equal to a specified lower-bound value, and less than or equal to a specified upper-bound value, the values in the Weighted Table (230) associated with the Key Data Model (220) used to calculate the distance are added to the Possibility Set. Once all of the keys have been iterated through, the Possibility Set is returned by the function.

An additional embodiment of a Selection Function (250) employing distance, denoted as “Distance Outside Range” is described herein, which is a modification of the general “Distance Threshold” (720) Selection Function (250). The intent of this type of Selection Function (250) is to allow Data Models (100) to generate output values which are associated with other Data Models (100) by similarity values defined by the Distance Function (160) which are outside a given range. The following is a specific embodiment of this intent. First a new Weighted Table, denoted the Possibility Set, is constructed to hold the valid values. Then, for each of the plurality of Keys in the AI object's Associative Container (210) the Distance Function (160) is used to calculate a distance between the input Data Model, and the Key Data Model. If the calculated distance is less than or equal to a specified lower-bound value, and greater than or equal to a specified upper-bound value, the values in the Weighted Table (230) associated with the Key Data Model (220) used to calculate the distance are added to the Possibility Set. Once all of the keys have been iterated through, the Possibility Set is returned by the function.

An additional embodiment of a Selection Function (250) employing distance, denoted as “Distance Maximum” is described herein, which is a modification of the general “Distance Threshold” (720) Selection Function (250). The intent of this type of Selection Function (250) is to allow Data Models (100) to generate output values which are associated with other Data Models (100) with the lowest similarity to the original Data Models (100) within a population of similarity values as defined by the Distance Function (160). The following is a specific embodiment of this intent. First a new Associative Container, denoted the Distance Table, is constructed to hold associative pairs of Key Distance Values, comprising a floating-point or integer value, and Value Weighted Tables, denoted as Possibility Sets. Then, a distance value, denoted as Maximum, is initialized to a default value. For each of the plurality of Keys in the AI object's Associative Container (210) the Distance Function (160) is used to calculate a distance between the input Data Model, and the Key Data Model. If the calculated distance is greater than the current Maximum value, the Maximum value is replaced with it. If the calculated distance is not already found in the Keys of the Distance Table, a new Possibility Set is created and inserted into the Distance Table with an associated Key value equal to the calculated distance. The values in the Weighted Table (230) associated with the Key Data Model (220) used to calculate the distance are then added to the Possibility Set associated to the Key Distance Value equal to the calculated distance. Once all of the keys have been iterated through, the Possibility Set with an associated Key equal to the Maximum value is returned.

An additional embodiment of a Selection Function (250) employing distance, denoted as “Distance Minimum” is described herein, which is a modification of the general “Distance Threshold” (720) Selection Function (250). The intent of this type of Selection Function (250) is to allow Data Models (100) to generate output values which are associated with other Data Models (100) with the highest similarity to the original Data Models (100) within a population of similarity values defined by the Distance Function (160). The following is a specific embodiment of this intent. First a new Associative Container, denoted the Distance Table, is constructed to hold associative pairs of Key Distance Values, comprising a floating-point or integer value, and Value Weighted Tables, denoted as Possibility Sets. Then, a distance value, denoted as Minimum, is initialized to a default value. For each of the plurality of Keys in the AI object's Associative Container (210) the Distance Function (160) is used to calculate a distance between the input Data Model, and the Key Data Model. If the calculated distance is less than the current Minimum value, the Minimum value is replaced with it. If the calculated distance is not already found in the Keys of the Distance Table, a new Possibility Set is created and inserted into the Distance Table with an associated Key value equal to the calculated distance. The values in the Weighted Table (230) associated with the Key Data Model (220) used to calculate the distance are then added to the Possibility Set associated to the Key Distance Value equal to the distance value. Once all of the keys have been iterated through, the Possibility Set with an associated Key equal to the Minimum value is returned.

An additional embodiment of a Selection Function (250) employing distance, denoted as “Distance Average” is described herein, which is a modification of the general “Distance Threshold” (720) Selection Function (250). The intent of this type of Selection Function (250) is to allow Data Models (100) to generate output values which are associated with other Data Models (100) with similarity to the original Data Models (100) within some specified margin of an average similarity value calculated from a population of distance values defined by the Distance Function (160). The following is a specific embodiment of this intent. First, a floating-point value, denoted as the Distance Sum is initialized to a value of 0, and an unsigned integer, denoted as Count, is initialized to a value of 0. For each of the plurality of Key Data Models (220) in the AI Model's (220) Associative Container (210), the Distance Function (160) is used to calculate a distance between the input Data Model and the Key Data Model. The calculated distance is added to the Distance Sum value, then 1 is added to the Count value. Once each of the keys have been iterated through, the Count is converted to a floating-point value, and the Distance Sum is divided by the newly converted Count value to calculate a value, denoted as Average Distance. Then, a new Weighted Table, denoted the Possibility Set, is constructed to hold the valid values. For each of the plurality of Key Data Models (220) in the AI Model's (220) Associated Container (210), the Distance Function (160) is used to calculate a distance between the input Data Model, and the Key Data Model. If the calculated distance is within some specified margin of error of the Average Distance, the values in the Weighted Table (230) associated with the Key Data Model (220) used to calculate the distance are added to the Possibility Set. Once each of the keys have been iterated through, the Possibility Set is returned by the function.

An additional embodiment of a Selection Function (250) employing distance, denoted as “Distance Median” is described herein, which is a modification of the general “Distance Threshold” (720) Selection Function (250). The intent of this type of Selection Function (250) is to allow Data Models (100) to generate output values which are associated with other Data Models (100) with similarity to the original Data Models (100) equal to the median similarity value from a population of distance values defined by the Distance Function (160). The following is a specific embodiment of this intent. First, a floating-point value, denoted as the Median, is initialized to a value of 0, and a dynamic array of distance values, denoted as the Distance Array, is created. For each of the plurality of Key Data Models (220) in the AI Model's (220) Associative Container (210), the Distance Function (160) is used to calculate a distance between the input Data Model and the Key Data Model. The calculated distance is added to the Distance Array. Once each of the keys have been iterated through, the values in the Distance Array are re-ordered such that the first value is the lowest distance value, each subsequent distance value is greater than its immediate preceding value, and less than its immediate succeeding value, and the highest distance is the last value in the Distance Array. Next an unsigned integer value, denoted as Median Index, is created. If the number of elements in the Distance Array is evenly divisible by 2, the size of the Distance Array is divided by 2, then 1 is subtracted from it to calculate the Median Index value. If the number of elements in the Distance Array is not evenly divisible by 2, the size of the Distance Array has 1 subtracted from it, which is then divided by 2 to calculate the Median Index value. The Median is set to the value in the Distance Array with the calculate Median Index value. Then, a new Weighted Table, denoted the Possibility Set, is constructed to hold the valid values. For each of the plurality of Key Data Models (220) in the AI Model's (220) Associated Container (210), the Distance Function (160) is used to calculate a distance between the input Data Model, and the Key Data Model. If the calculated distance is equal to the Median value, the values in the Weighted Table (230) associated with the Key Data Model (220) used to calculate the distance are added to the Possibility Set. Once each of the keys have been iterated through, the Possibility Set is returned by the function.

Referring to FIG. 8B, a flow-graph illustrating the logic of an embodiment of a Collapse Function (260), denoted as Max Collapse (820) is illustrated. First, a maximum value is determined by iterating through the table, and if a given value has a weight greater than the current maximum, it is set as the selected (804). Once iterating has completed, the current highest selected value is returned (826).

Additional embodiments may be produced by applying any of the previously described alterations to any arbitrary collection of Data Model (100) objects and data types. As such, the following embodiments are set forth as specific embodiments, illustrating the ease with which anyone of ordinary skill in the Art might make obvious alterations to create an embodiment of the invention, system and methods described herein, which it will be apparent are covered by the scope of the invention. For the purposes of each embodiment, any arbitrary Selection Function (250) and Collapse Function (260), chosen from, but not limited to, those already described herein may be employed.

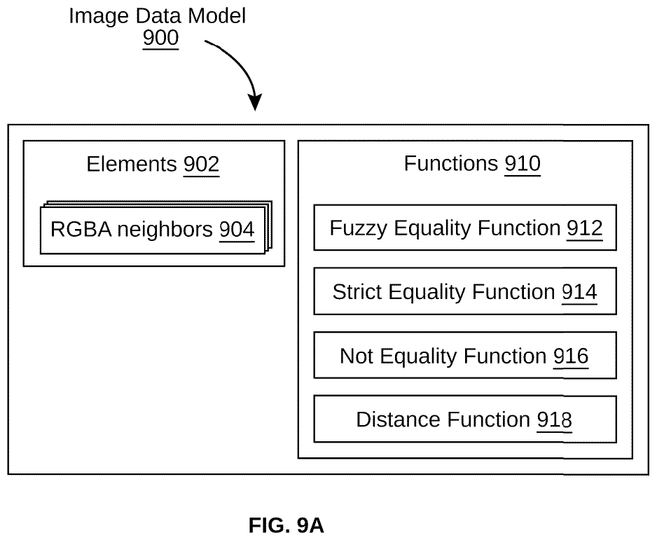

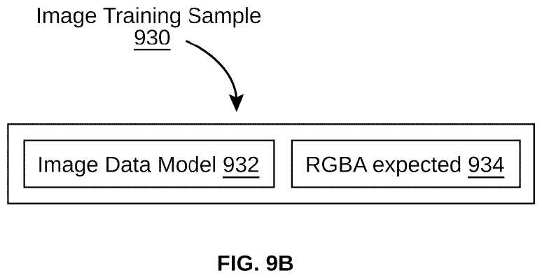

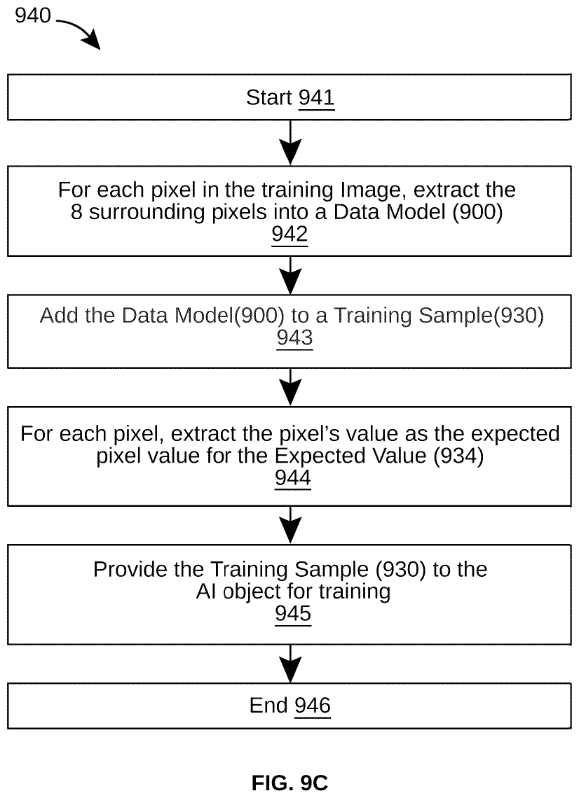

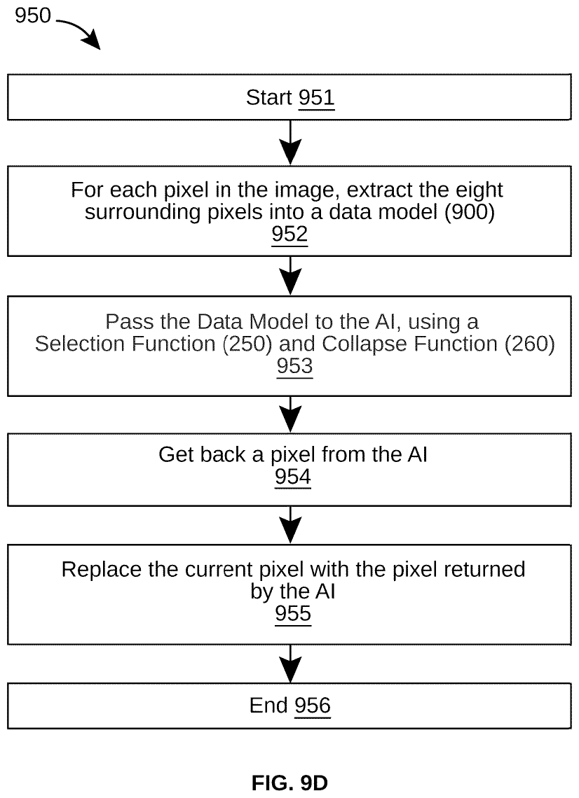

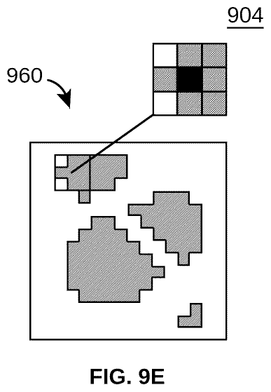

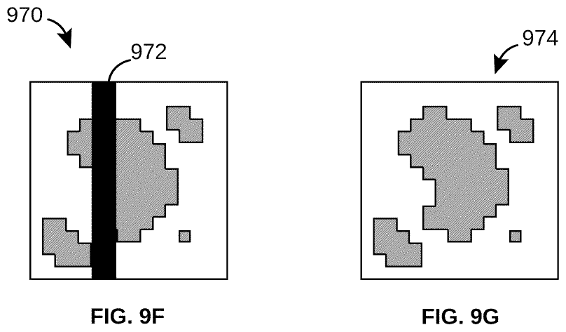

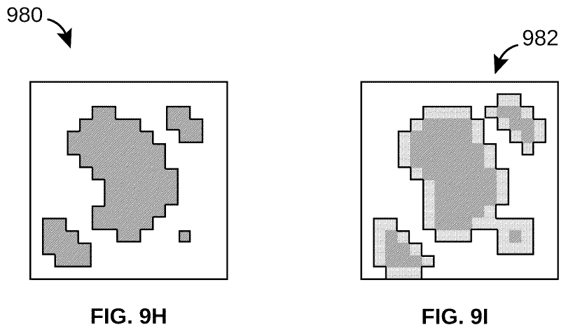

Referring to FIG. 9A, the architecture of a specific alteration of a Data Model (100) for use with images denoted an Image Data Model (900), is shown. In this alteration the Elements (110) of the Image Data Model (902), are comprised of but not limited to, a plurality of RGBA pixel values denoted as neighbors (904). An RGBA value is a 32-bit unsigned integer, four-value element where each sub-value, referred to as channels, denoted Red, Green, Blue and Alpha, is represented by either a real number value in the range of 0 to 1, or an 8-bit unsigned integer value. The Functions (120) of the Image Data Model (910) are also each defined according to arbitrary specifications meeting the criteria as set forth in descriptions of the Data Model (100) but operating on the Elements of the Image Data Model (902).

The Fuzzy Equality Function (912) takes in two Image Data Models (900), and optionally a collection comprising one or more RGBA “wildcard” values, and returns true if each of the neighbors in the two Data Models are equal, or equal to one of the wildcard values. The Strict Equality Function (914) takes in two Image Data Models and returns true only if each of the corresponding neighbor RGBA values are equal. The Not Equality Function (916) returns the logical complement of the Fuzzy Equality Function (912). The Distance Function (918) returns a distance value as calculated by the following formula, where syntax such as r_B denotes the Red value from the Data Model indicated by the variable B.

$$dist ( A , B ) = \sqrt{{( {r}_{B} - {r}_{A} )}^{2} + {( {g}_{B} - {g}_{A} )}^{2} + {( {b}_{B} - {b}_{A} )}^{2} + {( {α}_{B} - {α}_{A} )}^{2}}$$

Referring to FIG. 9B, the architecture of a specific alteration of a Training Sample (300) for use with images denoted an Image Training Sample (930), is shown. In this alteration the Data Model (310) of the Image Training Sample (932), is comprised of an Image Data Model (900). The Expected Value (320) of the Image Training Sample (934) is an RGBA value, representing an expected pixel value to be associated with the given Image Data Model (900) as input (932).

Referring to FIG. 9C, a flow-graph illustrating the general steps for training an AI (200) using an Image Data Model (900) and Image Training Samples (930), denoted as an Image AI, is illustrated (940). For each pixel in a given image, the 8 surrounding pixels, and optionally, the central pixel, are extracted in to an Image Data Model (900) (942) which is set as the Data Model in an Image Training Sample (932) (943), and the pixel value is set as the Expected Value (320) in the Image Training Sample (934) (944). Then the Image Training Sample (930) is provided to the AI structure (200) for training (945).

Referring to FIG. 9D, a flow-graph illustrating the general steps for employing an Image AI, is illustrated (950). For each pixel in an image, the eight surrounding pixels, and optionally the central pixel, are extracted into an Image Data Model (900) (952). The Image Data Model (900) is passed to the Image AI (953), which will utilize any provided pair of Selection Function (250) and Collapse Function (260), such as but not limited to Fuzzy Match (700), Distance Threshold (720), Distance Ordering (740), Distance Gradient (780), Random Collapse (800) and Max Collapse (820), which returns an RGBA pixel value (954). The current pixel is replaced by the returned value (955).

Referring to FIG. 9E, an example of an image (960) is illustrated, with the eight neighbor RGBA pixel values (904) being extracted.

Referring to FIG. 9F, an example of an image (970) with missing or damaged pixels (972).

Referring to FIG. 9G, an example of the previous image (970) after an Image AI was employed on only the damaged pixels (974).

Referring to FIG. 9H, an example of an image (980).

Referring to FIG. 9I, an example of the previous image (980) after an Image AI was employed on all the pixels in the image for the purpose of updating the pixel values according to training information (982).

An additional alteration of the Image AI System training process (940), for use with multiple images, denoted as a “Multi-Image AI Training” is described herein. The purpose of this alteration is to facilitate more sophisticated image generation methods, such as, but not limited to those employed in real-time applications, including video games and computer generated imagery. This embodiment behaves in an identical manner to the Image AI System, except in the matter of training. During the process of training, two separate images, denoted as the Source, and the Result, are employed, which must be of the same width and height.

Referring to FIG. 9C, during the construction of the Image Data Model (900) for the Image Training Sample (930) (942), all values for the Data Model are extracted from the Source image. Then, during the process of constructing the expected value (934), each value is extracted from the Result image.

Additionally, an alteration of the Image AI System, denoted as “Multi-Pass Image AI” is described herein. The purpose of this alteration is to facilitate image generation for applications which employ multiple images in the process of synthesizing an output image, such as, but not limited to software rendering systems, such as those employed in video games and computer-generated imagery. One embodiment of this intent is described herein.

Referring to FIG. 9A, an alteration is made to the “Image Data Model”, denoted as a “Multi-Pass Image Data Model”, whereby a plurality of groups of RGBA neighbor values, denoted herein as Image Passes, replace the singular group of RGBA neighbor values (904).

Referring to FIG. 9B, an alteration is made to the “Image Training Sample” (930), denoted as a “Multi-Pass Image Training Sample”, whereby the Data Model (932) is changed from an Image Data Model (900) to the more specialized Multi-Pass Image Data Model.

Referring to FIG. 9C, an alteration to the Image AI Training Process (940) for training Multi-Pass Image AI is described herein. During the process of constructing a Multi-Pass Image AI Training Sample, a group of images with equal width and height values, denoted as the Input Passes, are employed in conjunction with an additional image, with an equal width and height value to the Input Passes, denoted as the Result. During the process of constructing a Multi-Pass Image Training Sample's Data Model (942), for each of the values in the collection of Image Passes, a collection of pixels is extracted from a corresponding image in the Input Passes, in a manner as described in the original Image AI training process (942). Then, during the process of constructing a Multi-Pass Image Training Sample's expected value (944), each pixel value is extracted from the Result image.

Referring to FIG. 9D, an alteration to the Image AI Usage Process (950) for employing Multi-Pass Image AI is described herein. During the process of constructing a Multi-Pass Image Data Model to use as input to the Multi-Pass Image AI (952), a plurality of images corresponding to the Image Passes in the Multi-Pass Image AI Data Model are employed. For each image, a collection of RGBA values are extracted to a corresponding Image Passes collection in a manner similar to the process for a simple Image AI (952). This allows the Multi-Pass Image AI to employ multiple input images, thereby employing multiple data sources to determine the resulting value for an output image.

Herein a voxel refers to a generalization of a pixel to many dimensions which stores arbitrary data and associates it with coordinates in a discretely divided space. For the sake of the following embodiment of the invention, a voxel will be comprised of, but not limited to, a type identifier, represented as an unsigned 64-bit integer, and an unsigned integer value denoting some notion of height. Given the nature of voxels as a general data structure, it will be clear to anyone of ordinary skill in the Art, that the following embodiment may be easily altered such that any such iteration of a voxel data structure may be employed while the nature of the invention remains the same, and therefore falls within the Scope of the invention.

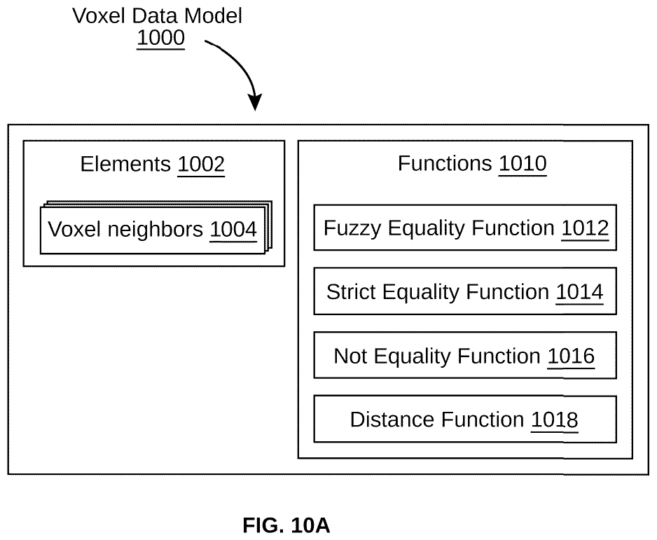

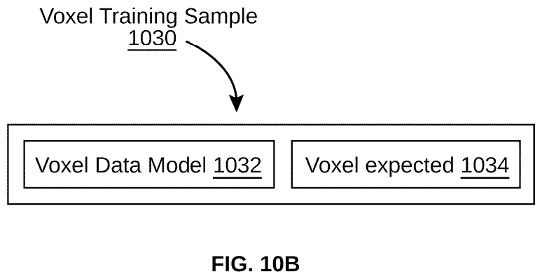

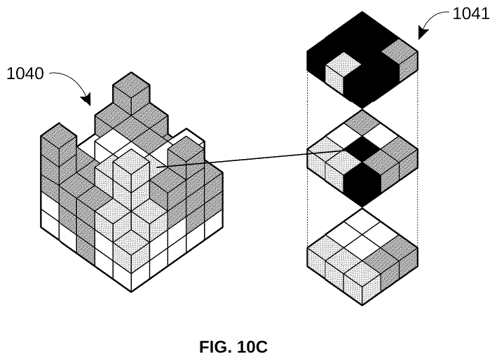

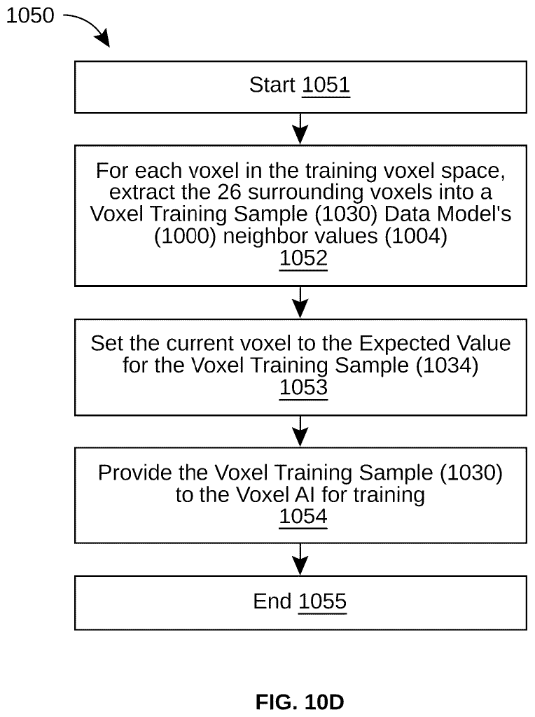

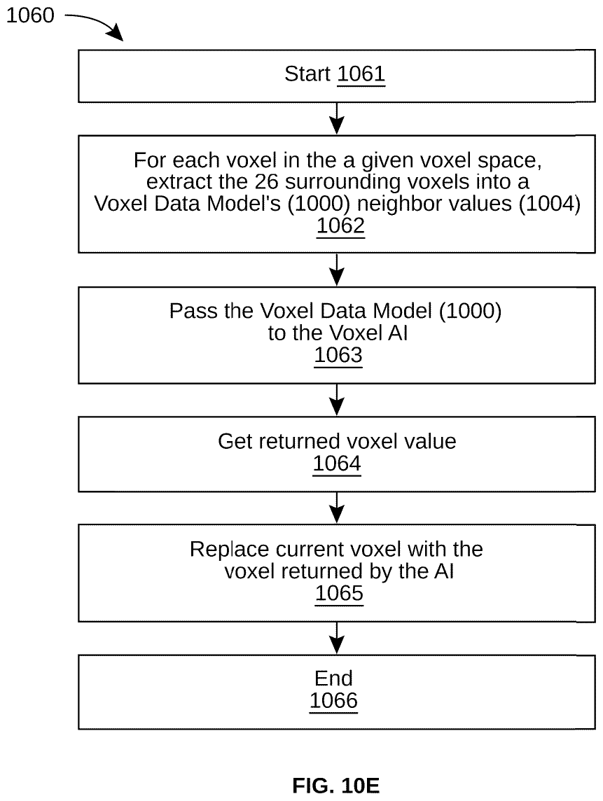

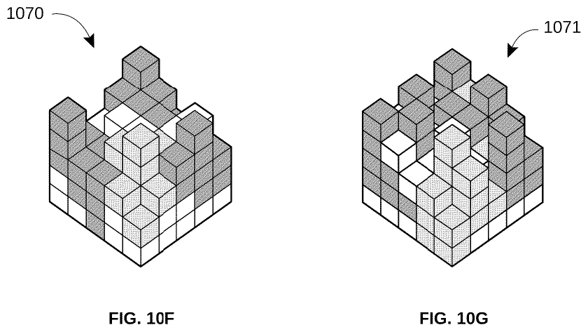

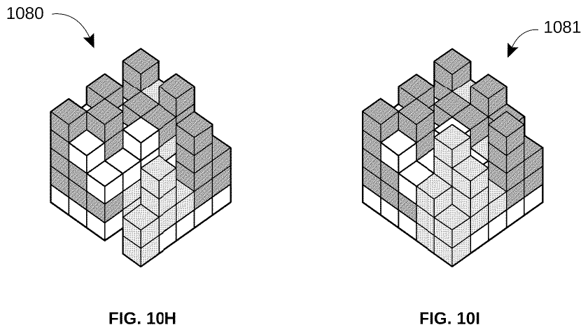

Referring to FIG. 10A, the architecture of a specific alteration of a Data Model (100) for use with voxels denoted a Voxel Data Model (1000) is illustrated. In this alteration the Elements (110) of the Voxel Data Model (1002), are comprised of but not limited to, a plurality of voxels, denoted as neighbors (1004). The Functions (120) of the Voxel Data Model (1010) are also each defined according to arbitrary specifications meeting the criteria as set forth in descriptions of the Data Model (100) but operating on the Elements of the Voxel Data Model (1002).

The Fuzzy Equality Function (1012) takes in two Voxel Data Models (1000), and optionally a collection comprising one or more voxel “wildcard” values, and returns true if each of the neighbors in the two Voxel Data Models are equal, or equal to one of the wildcard values. The Strict Equality Function (1014) takes in two Data Models and returns true only if each of the corresponding neighbor voxel values are equal. The Not Equality Function (1016) returns the logical inverse of the Fuzzy Equality Function (1012). The Distance Function (1018) returns a distance value based on some arbitrary formula, which may generally be considered as analogous to a standard distance formula.

Referring to FIG. 10B, the architecture of a specific alteration of a Training Sample (300) for use with voxels denoted a Voxel Training Sample (1030), is shown. In this alteration the Data Model (310) of the Voxel Training Sample (1032), is comprised of a Voxel Data Model (1000). The Expected Value (320) of the Voxel Training Sample (1034) is a voxel, representing an expected voxel to be associated with the given Voxel Data Model (1000) as input (1032).

Referring to FIG. 10C, a voxel space comprised of voxels, represented graphically as cubic volumes, is depicted (1040), with a sample of 26 neighboring voxels, and optionally the central voxel, being extracted (1041) for use as neighbors (1004) in a Voxel Data Model (1000) also illustrated. Black voxels are depicted to indicate either empty voxels, or the central voxel which is omitted from the sample.

Referring to FIG. 10D, a flow-graph illustrating the general steps for training a Voxel AI, is illustrated (1050). For each voxel a Voxel Training Sample (1030) is created, and the surrounding 26 voxels, and optionally the central voxel, (1041) are loaded into the plurality of neighbors (1004) in the Voxel Data Model (1032) (1052). Then the Expected Value (320) of the Voxel Training Sample (1034) is set to the current voxel (1053). The constructed Voxel Training Sample (1030) is then passed to the Voxel AI for training (1054).

Referring to FIG. 10E, a flow-graph illustrating the general steps for employing a Voxel AI, is illustrated (1060). For each voxel a Voxel Data Model (1000) is created, and the surrounding 26 voxels (1041) are extracted into the plurality of neighbors (1004) in the Voxel Data Model (1000) (1062). Pass the constructed Voxel Data Model (1000) to the Voxel AI (1063). Get the returned value (1064) and replace the current voxel with the value returned by the AI (1065).

Referring to FIG. 10F, a voxel space is illustrated (1070).

Referring to FIG. 10G, the previous voxel space (1070) after a Voxel AI was employed to update the voxels based on training data is illustrated (1071).

Referring to FIG. 10H, a voxel space with a missing section of voxels is illustrated (1080).

Referring to FIG. 10I, the previous voxel space (1080) after a Voxel AI was employed to replace the missing voxels is illustrated (1081).

In the field of 3D animation a data structure referred to as an armature may be employed in puppeteering a 3D model, which is a collection of various hierarchically organized data structures denoted as “bones”, organized in a data structure commonly referred to in the Art as a “tree” or “graph”, employed in the animation of an object in a virtual 3D system, such as but not limited to, an animated film or video game. Herein a hierarchical structure of bones is referred to as a rig or armature. Herein a bone will be reduced in description to only those elements as are necessary for the sake of discussion of the present embodiment of the invention, with consideration that this description trivially extends to all such structures comprised of the following elements: an element, such as but not limited to, an unsigned integer, which may be used to uniquely identify the bone, denoted an “identifier”, a collection of one or more identifiers of additional bones or references to additional bones, denoted as either parent bones or children bones, which the present bone has some relationship to and may optionally inherit qualities from or pass qualities to, such as mathematical ones, such as but not limited to, a geometrically scaling value, represented as a vector comprised of 3 scalar 64-bit floating-point values denoted as “scale”, a rotation vector, herein comprised of 3 scalar 64-bit floating-point elements, denoting rotation relative to a specific parent bone or reference object, denoted as “rotation”, and a vector, herein comprised of 3 scalar, 64-bit floating-point values, denoted as “location”. For the sake of the embodiment as described herein, these elements will be considered the specific elements of the embodiment. Given the nature of hierarchical trees, and armatures as two common data structures in the Art, it will be will be clear to anyone of ordinary skill in the Art, that the following embodiment may be easily altered such that any such iteration of a tree, as employed in the management of relative geometric objects, or armature data structure may be employed while the nature of the invention remains the same, and therefore falls within the Scope of the invention.

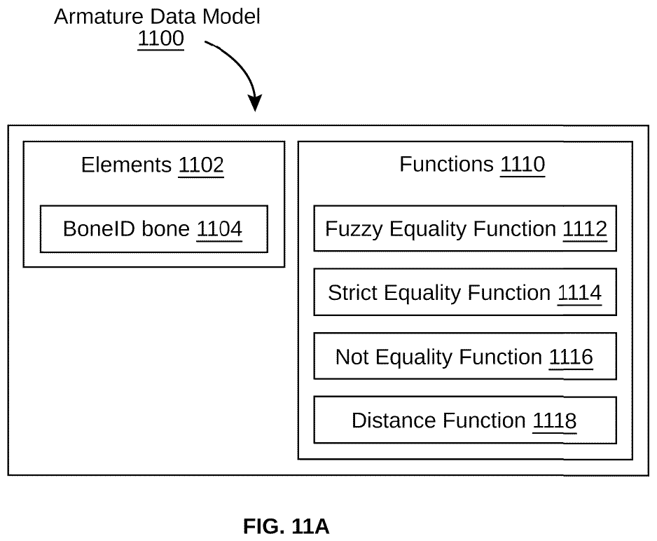

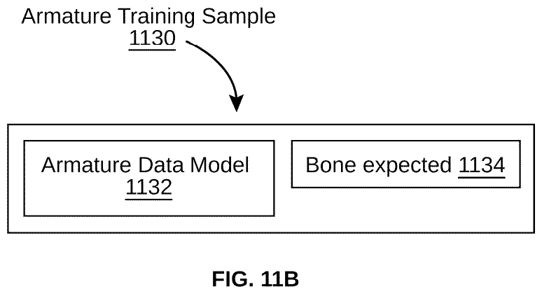

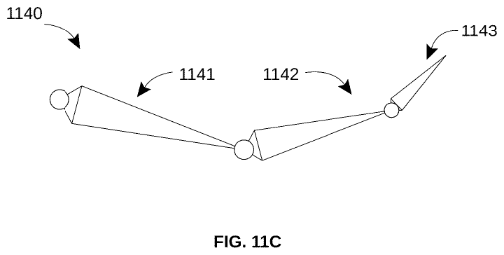

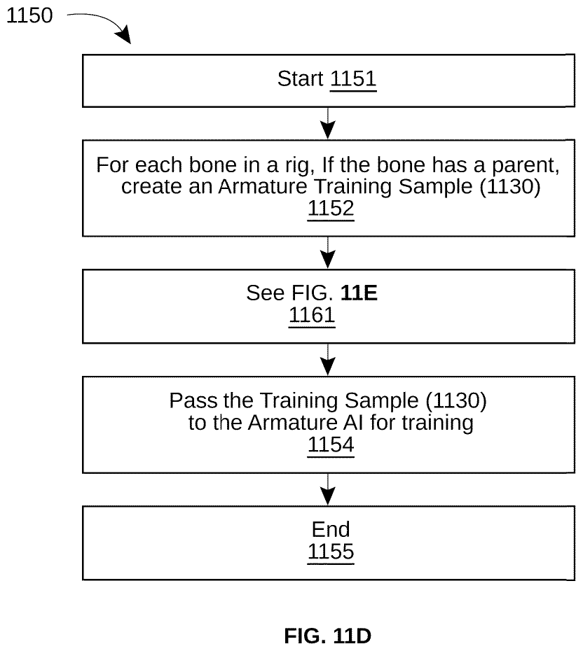

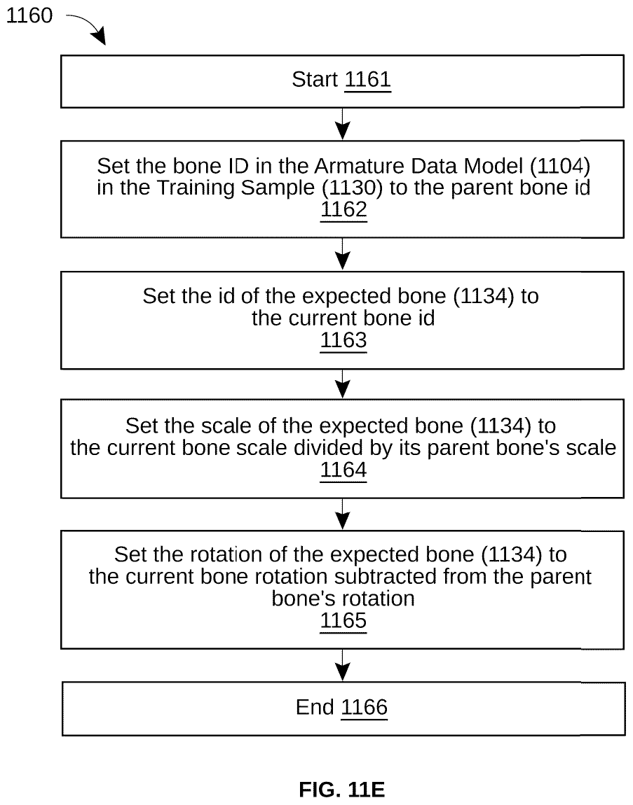

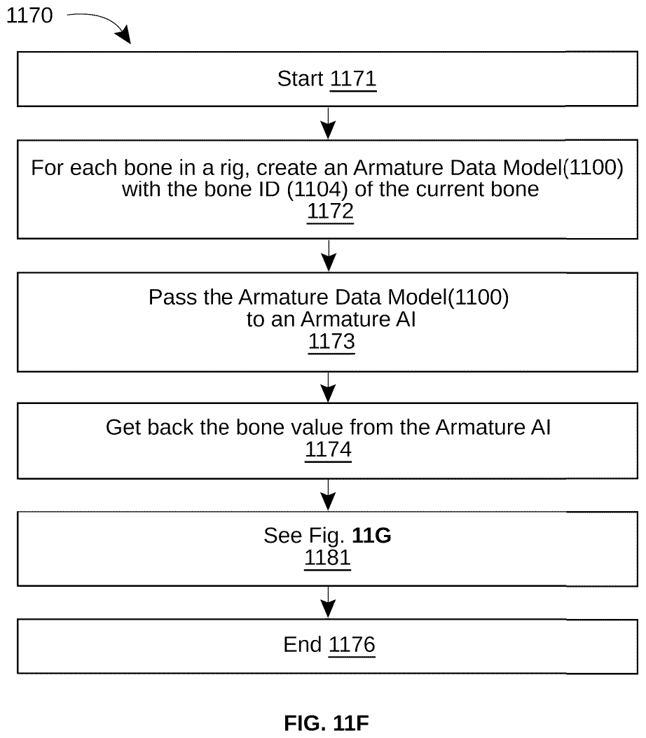

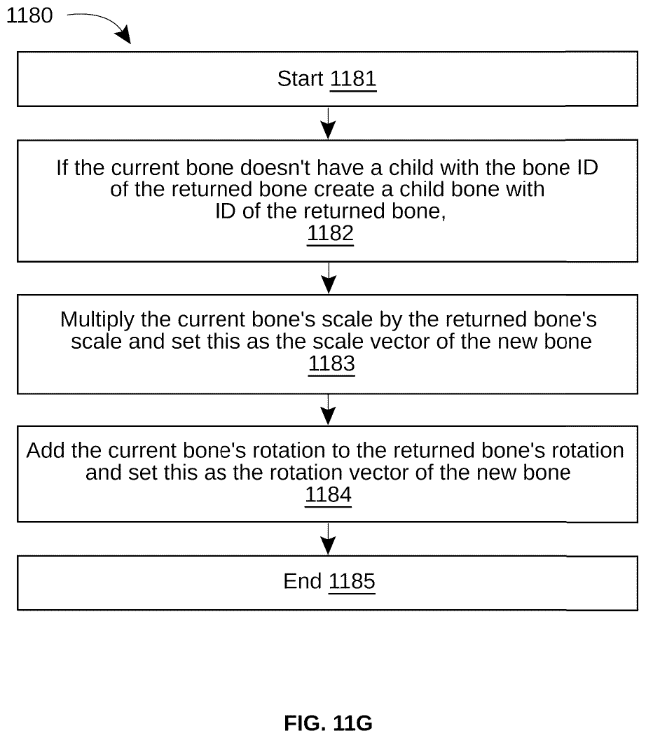

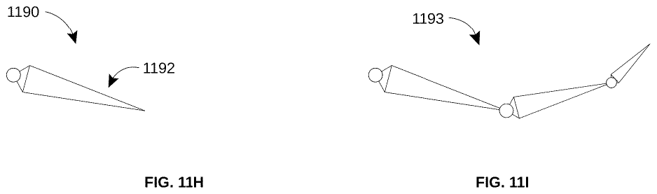

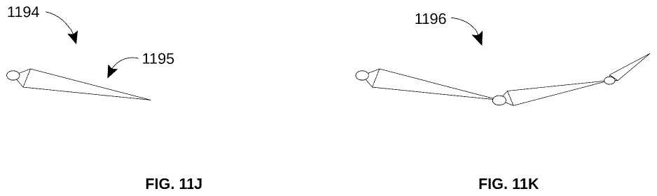

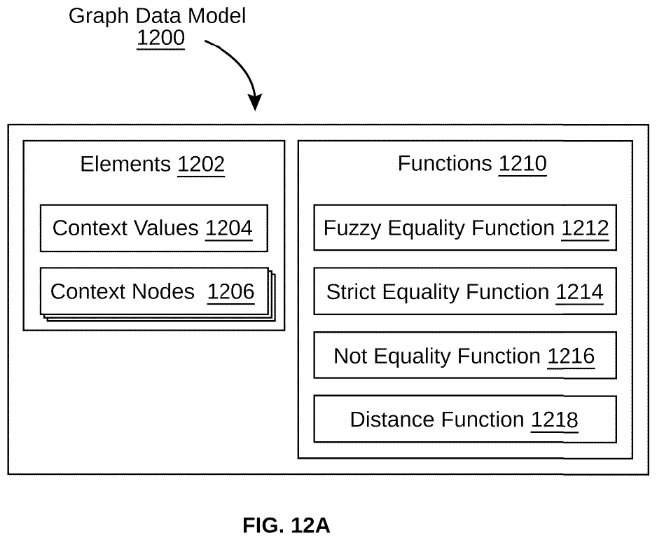

Referring to FIG. 11A, the architecture of a specific alteration of a Data Model (100) for use with 3D armature data denoted an Armature Data Model (1100), is shown. In this alteration the Elements (110) of the Armature Data Model (1102), are comprised of but not limited to, a value of arbitrary type employed in identifying a bone within a greater rig, denoted as bone (1104), but referred to herein as bone id, and analogous to the Bone identifier mentioned above. The Functions (120) of the Armature Data Model (1110) are also each defined according to arbitrary specifications meeting the criteria as set forth in descriptions of the Data Model (100) but operating on the Elements of the Armature Data Model (1002).

The Fuzzy Equality Function (1122) takes in two Armature Data Models (1100), and returns true if the bone identifiers are identical, or have patterns which are similar under some arbitrary schema, such as the text identifiers, “L_Arm” and “R_Arm” being considered equitable. The Strict Equality Function (1124) takes in two Armature Data Models (1100) and returns true only if the bone identifiers are identical. The Not Equality Function (1026) returns the logical complement of the Fuzzy Equality Function (1122). The Distance Function (1128) returns a distance value based on some arbitrary method of calculating distance from a given pair of identifier values, or remains undefined.

Referring to FIG. 11B, the architecture of a specific alteration of a Training Sample (300) for use with 3D armature data denoted an Armature Training Sample (1130), is shown. In this alteration the Data Model (310) of the Armature Training Sample (1132), is comprised of an Armature Data Model (1100). The Expected Value (320) of the Armature Training Sample (1134) is a bone, representing a bone to be associated with the given Armature Data Model (1100) as input (1132). This bone stores a rotation vector, location vector and scale vector relative to the parent bone it is associated with. In the circumstance that a location value is not denoted, a bone is said to possess a relative location vector of value (0,0,0), denoting no displacement from the parent bone.

Referring to FIG. 11C, an example of an armature rig of a simple arm, comprised of three bones is illustrated (1140). The largest bone is denoted the Humerus, with no parent, a scale of (1.0, 1.0, 1.0), and a rotation of (−15, 0, 0) (1141). The second largest bone, which has the Humerus as parent, has a scale of (0.8, 0.8, 0.8), relative rotation of (30, 0, 0) and is denoted the Ulna (1142). The last bone, which has the Ulna as parent, a scale of (0.5, 0.5, 0.5) and rotation of (30, 0, 0) is denoted the Hand (1143).

Referring to FIG. 11D, a flow-graph illustrating the general steps for training an Armature AI, is illustrated (1150). For each bone in a given rig, if the bone has a parent create an Armature Training Sample (1130) and proceed to 1161 (1152).

Referring now to FIG. 11E, set the bone identifier in the Armature Data Model (1104) within the Armature Training Sample (1130) to the bone identifier of the parent of the current bone, or, if a pattern processing system is employed, to an abstract pattern, such as “*_Arm” if the parent bone identifier were “R_Arm”, based on the bone identifier of the parent of the current bone (1162). Then set the identifier of the expected bone (1134) to the current bone's identifier (1163). Calculate the relative scale of the current bone by dividing each element in the scale vector of the current bone by the corresponding element in the parent bone's scale vector, and set the scale of the expected bone to the relative scale value (1164). Calculate the relative rotation of the current bone by subtracting each angle element in the rotation vector of the current bone by the corresponding element in the parent bone's rotation vector, and set the rotation of the expected bone to the calculated relative rotation vector (1165). Optionally, calculate the relative location of the current bone by subtracting each element in the bone's location vector from each corresponding value in the parent bone's location vector, and divide the resulting vector by the corresponding scale vector value, then set the resulting vector as an optional relative offset value.

Referring now to FIG. 11D, pass the constructed Armature Training Sample (1130) to the Armature AI for training (1154).

Referring to FIG. 11F, a flow-graph illustrating the general steps for employing an Armature AI, is illustrated (1170). For each bone in a given input rig, create an Armature Data Model (1100) with the bone identifier (1104) set to the current bone's identifier (1172). Then, pass the Armature Data Model (1100) to the Armature AI (1173), and get back the bone value from the Armature AI (1174).

Referring now to FIG. 11G, check the children bones of the current bone, and if there is no child with an identifier matching the returned bone's identifier, create a new child bone with the returned bone identifier (1182). Multiply the current bone's scale vector by the returned bone's scale vector and assign the new scale vector to the newly created child bone's scale vector value (1183). Then, add the current bone's rotation vector to the returned bone's rotation vector to get a new rotation vector, and assign the new rotation vector to the newly created child bone's rotation vector value (1184). Optionally, multiply the offset vector by the previously multiplied scaling vector, and add the multiplied offset vector to the new bone's location vector to assign a scale-relative locational offset to the new bone.

Referring now to FIG. 11F, continue this process until no more bones are left to iterate over, no new children bones are being created, or some arbitrary condition is met.

Referring to FIG. 11H, an example of a rig (1190) is shown, which is only comprised of a single bone, denoted the “Humerus” (1192).

Referring to FIG. 11I, an example of a rig (1193) generated from the previous armature (1190) after the recursive application of an Armature AI trained on a similar rig such as 1140.

Referring to FIG. 11J, an example of a rig (1194) comprised of a single bone, denoted the Humerus (1195), with a non-uniform scale vector of (1.5,1,1) is illustrated.

Referring to FIG. 11K, an example of a rig (1196) generated from the previous armature (1194) after the recursive application of an Armature AI trained on a similar rig such as 1140 is illustrated. Note that although the training was on uniformly scaled armatures, the relative calculations enable generation on non-uniformly scaled armatures.

In a number of disciplines, a topological graph may be used as an initial data structure from which to generate additional data structures and models of systems. For example, in video games and other forms of 3D interactive entertainment, a topological graph may be used to connect points on a map before generating the associated full 3D environment geometries algorithmically. Additionally, a topological graph may be used in the planning and generation of sequential artistic works, such as music compositions. Herein a description is provided of a general software representation of an embodiment of the Invention which has been specialized to work with topological graph objects, denoted as a Graph AI. A node commonly refers to a software data structure which contains arbitrary data and is connected by one or more instances of a software data structure, commonly referred to in the Art as an edge, to other nodes in a structure often denoted as a graph, or more technically as a topological node graph or mesh. In this embodiment the term node may be used to specifically refer to a software implementation of a node, which, through the application of adaptable techniques, such as, but not limited to, Inheritance and Polymorphism, Object Composition, Prototype Inheritance and Templates, may be specialized to a further specific type of node which contains specific values and associated procedures particular to an adapted application. As such, the operations as described herein may be performed on nodes of arbitrary type, so long as the correct functions, as described in the description of the base Data Model (100) may be defined on them.

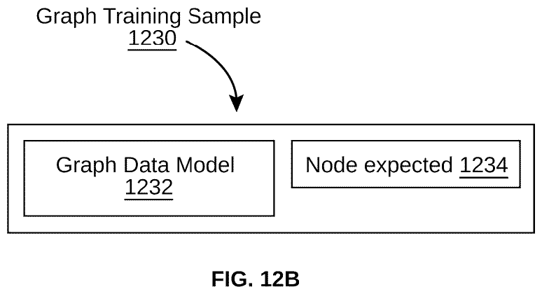

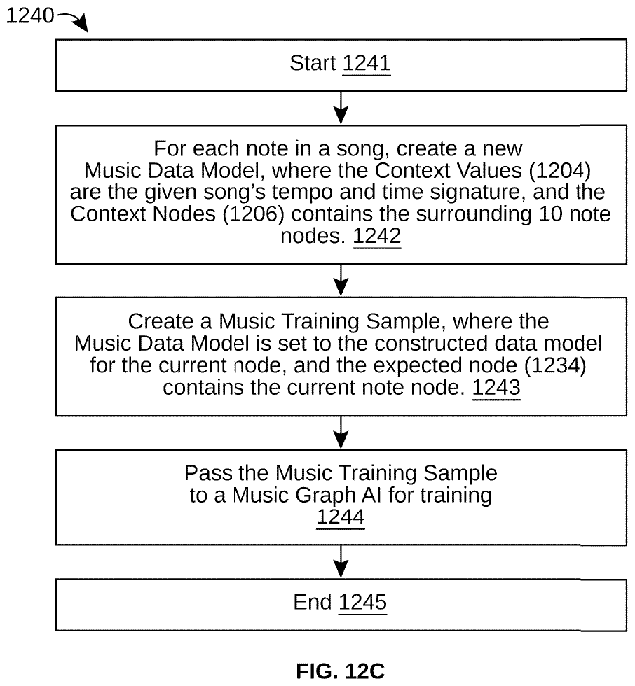

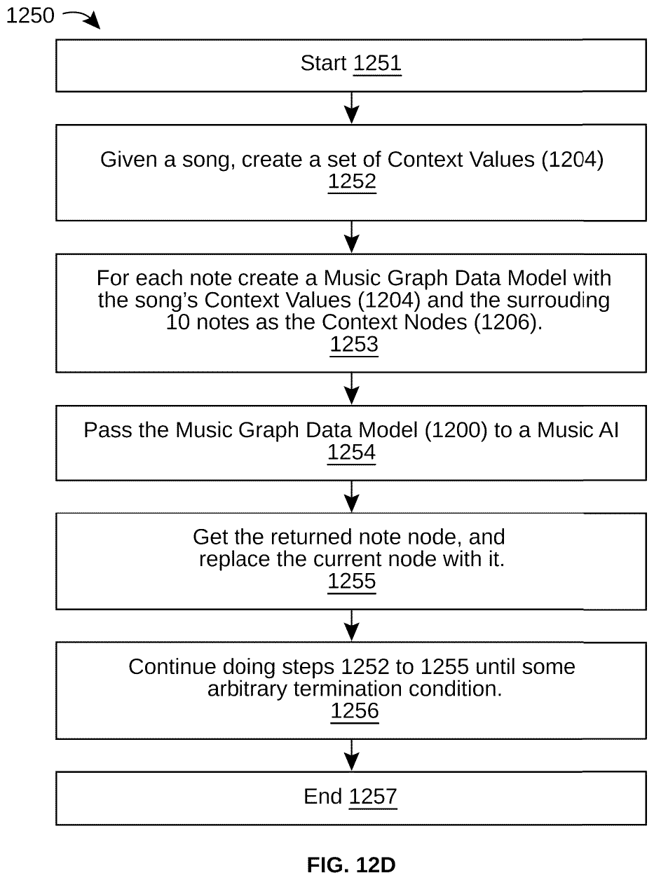

Referring to FIG. 12A, the architecture of a specific alteration of a Data Model (100) for use with topological node graphs containing arbitrary data, denoted a Graph Data Model (1200), is shown. In this alteration the Elements (110) of the Graph Data Model (1202), are comprised of but not limited to, a plurality of arbitrary non-node values, referred to herein as Context Values (1204), and a collection of one or more node references or pointer values, denoted as Context Nodes (1206), together collectively referred to as a node's Context. The Functions (120) of the Graph Data Model (1210) are also each defined according to some arbitrary specifications meeting the criteria as set forth in descriptions of the Data Model (100) but operating on the Elements of the Graph Data Model (1202).

When working with topological node graphs, or similar data structures, a notion of distance between two Node objects may be measured by a method commonly referred to in the Art as the Graph Geodesic Distance, or merely Geodesic Distance, whereby the shortest number of edges between two nodes in a graph are counted. For example, one may consider four points connected each by 2 edges to form a quadrilateral-shaped topological node graph. The top-left and top-right nodes are said to have a geodesic distance of 1, as there is only one edge between the two nodes. The top-left and bottom-right nodes are said to have a geodesic distance of 2, as the shortest paths between the two comprise two edges, either from the top-left node to bottom-left node, then bottom-left node to bottom-right node, or, alternatively, from the top-left node to top-right node, then top-right to bottom-right node.

For the purpose of the following descriptions, an arbitrary distance function, denoted as Context Distance, is said to be defined during the process of adaptation to a specific Context Values collection (1204) such that it returns an unsigned real-number, floating-point or integer value indicating some notion of distance between two collections of Context Values (1204). An additional distance function, denoted as Node Distance, is defined for all Graph Data Models (1200), which, given two Context Node collections (1206), calculates the sum of the Geodesic Distances between corresponding Nodes in the given Node Contexts (1206), to derive a total distance. The Fuzzy Equality Function (1212) takes in two Graph Data Models (1200) and counts the number of Context Values (1204) shared by the two models, denoted herein as the Context Count, and counts the number of Context Nodes (1206) shared by the two models, denoted herein as the Node Count, and returns true if both the Context Count and Node Counts exceed respectively specified values. The Strict Equality Function (1214) takes in two Graph Data Models (1200) and returns true only if all of the Context Nodes (1206) and Context Values (1204) in both provided Graph Data Models (1200) are considered identical. The Not Equality Function (1216) returns the opposite or logical complement of the Fuzzy Equality Function (1212). The Distance Function (1218) returns the sum of the Context Distance and the Node Distances between the corresponding Context Values (1204) and Context Nodes (1206) of the provided Graph Data Models (1200).

Referring to FIG. 12B, the architecture of a specific alteration of a Training Sample (300) for use with topological graphs containing arbitrary data, denoted a Graph Training Sample (1230), is shown. In this alteration the Data Model (310) of the Graph Training Sample (1232) is comprised of a Graph Data Model (1200). The Expected Value (320) of the Graph Training Sample (1234) is a node, denoted as Expected (1234), containing one or more arbitrary, application specific data values. representing a node possessing arbitrary data to be associated with a given Graph Data Model (1200) as input (1232).

The specific process by which a Graph AI may be trained is similar in nature to the process by which each embodiment of the Invention may be trained (400), with specific alterations to the process derived from the adaptations to specific applications.

In musical notation, a composition may possess a set of contextual values, such as, but not limited to, a time signature, comprised of a beat duration, indicating the numerical note value comprising a single beat, and beats per bar, indicating a number of beat values which a piece may be evenly divided into, a tempo, indicating the number of beats per unit of time, commonly a minute, and a set of musical notes, comprised of a pitch, indicating the acoustic frequency characteristics of a note, and a duration, indicating a numerical length for which a note is sustained upon being played by a musician or performing device. A pitch is comprised of an octave, denoted by an integer value, often ranging from 0 to 8, with lower octave values indicating a corresponding lower frequency, and pitch-class, denoted by a letter in the range of A to G, with increments from A to G correlating to a rise in acoustic frequency. In addition, when multiple notes are played in unison, this is commonly referred to by practitioners in music as a “chord”.

Herein the architecture of a specific alteration of a Graph Data Model (1200) for use with musical notation, denoted a Music Graph Data Model, is described. A Music Graph Data Model specializes the Context Values (1204) of a Graph Data Model (1200) to contain an unsigned integer indicating musical tempo, denoted as Tempo, an unsigned integer indicating beat duration, denoted as Beat Duration, an unsigned integer indicating the number of beat values per bar, denoted as Bar Length, and a variable length textual string value denoted as Artist. The Context Nodes (1206) are comprised of, but not limited to, 10 Note Nodes, as defined below, with five nodes indicating notes existing up to a Geodesic Distance of 5 preceding the current node upon graph construction, and five nodes indicating notes existing up to a Geodesic Distance of 5 following the current node upon graph construction, collectively known as the Note Node Context. A Note Node is a specialization of a node, as defined herein, with at least, but not limited to, a plurality of note values, comprised of, but not limited to, an 8-bit unsigned integer value denoted as an Octave, indicating musical octave, and an 8-bit unsigned integer value, denoted as a Pitch Class, indicating musical pitch class. An alternative representation employing a single 8-bit unsigned integer value, combining the notions of Octave and Pitch Class, may also be employed, as is common in the practice of musical encoding, such as is found in the technical specification for Musical Instrument Digital Interfaces, commonly referred to as MIDI.

The Context Distance function for a Music Graph Data Model is defined as the numerical sum of the distances between the Tempo, Beat Duration and Bar Length scalar values.

Referring to FIG. 12C, a flow-graph illustrating the general steps for training a Music Graph AI, is illustrated (1240). Given a song, for each note or chord in the song create a new Music Graph Data Model where the Context Values (1204) are the given tempo and time signature values of the song, and the Context Nodes are the 5 Note Nodes directly preceding and following the node in the song (1242). If there are not 5 preceding, or 5 following Note Nodes, the value of Note Nodes in the Context Nodes is reduced accordingly to the maximum number of notes in each direction which are present in the song. If a note or chord is come across in this process which is not already within a Note Node, construct a simple Note Node and set the value of the node to the note or chord, such that all notes played at a given moment in time are contained within a specific Note Node. Connect each Note Node by edges to the corresponding Note Nodes of temporally adjacent notes or chords. Then create a Graph Training Sample (1230), herein denoted as a Music Training Sample, and set the Music Data Model (1232) to the constructed Music Data Model, and the expected node (1234) to the current note node (1243). Then pass the Music Graph Training Sample (1230) to the Music Graph AI (1244).

Referring to FIG. 12D, a flow-graph illustrating the general steps for employing a Music Graph AI, is illustrated (1250). First, given a song, construct a Context Values object (1204) from the tempo, time-signature and artist. (1252). Beginning at the first note, create a Music Graph Data Model with the already constructed Context Values, and employing the preceding 5 notes, and following 5 notes to construct the Context Nodes (1206) (1253). Pass the Music Graph Data Model (1200) that has been constructed to a Music Graph AI (1254), get the returned note node value, and replace the current note in the song with the returned note value (1255). Continue with the previous steps 1252 to 1255 until some arbitrary termination condition is met such that the notes generated are considered sufficient for the application (1256).

A Finite State Automata, herein referred to by the abbreviation FSA, also known as a Finite State Machine, herein referred to by the abbreviation FSM, is a mathematical model and corresponding software technique for creating context-dependent, complex logical software agents commonly employed in the Art. An FSA is comprised of, but not limited to, a plurality of objects denoted as State Machines, comprising of but not limited to, a state indicator value, referred to as the State, and one or more functions which can change the state, denoted as State Transition Functions. An FSA State Machine may also contain a plurality of one or more additional elements, including, but not limited to, additional values and functions. Of these additional functions, some may be shared between one or more FSA State Machine objects, collectively referred to as the Interface Functions. The exact logical or mathematical definition of each given Interface Function may change for each unique State Machine within an FSA. When employed, an FSA has a current State Machine that is said to be the active or current State. When a function is said to be invoked, the specific function definition belonging to the active State Machine is employed, and the values of variables for the sake of the logic associated with the FSA are those set in the current State Machine, or encapsulating FSA structure itself. The current State Machine may be changed by the arbitrary programmatic execution of a State Transition Function, which will determine the new State and change the current State Machine to the State Machine with the corresponding State object. The change in State Machine object allow an FSA to change the logical behaviors under which the FSA operates in response to arbitrary programmatic logics. This allows an FSA to be employed in the Art for authoring complex software agent systems.

Aside from operations on distinct data structures, the invention may also be employed in embodiments for the purpose of generating logical behaviors, from learned data during the operation of the system. For example, in a software business environment for the purpose of automated remediation of operational system errors. Additionally, one may be employed in a video game or similar simulated environmental system, where a player driven avatar, denoted as a “player character” or “PC”, may have a state object which tracks various values of the character, such as, but not limited to, hunger, health, mood and energy, in addition to the decisions taken by a player encoded in some arbitrary data structure herein referred to as a Decision object. Such information can then be used to train an embodiment of the invention for the purpose of directing a machine-driven agent, denoted as a “non-player character” or “NPC”.

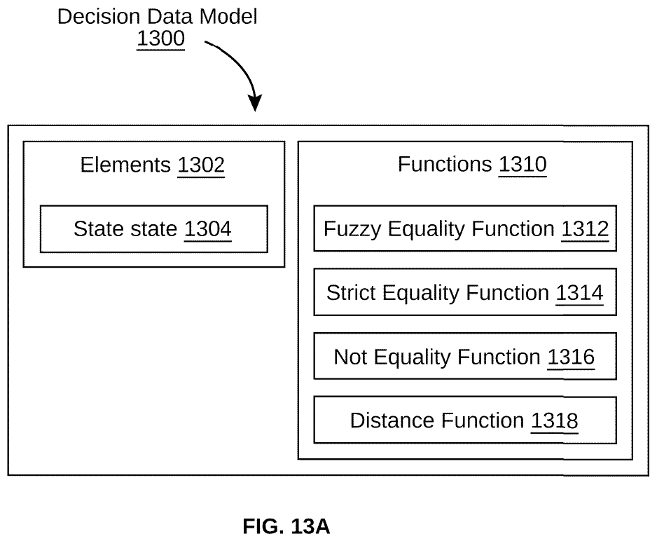

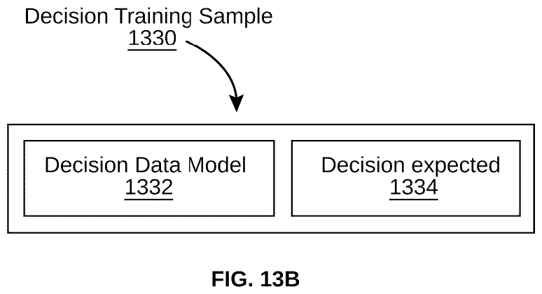

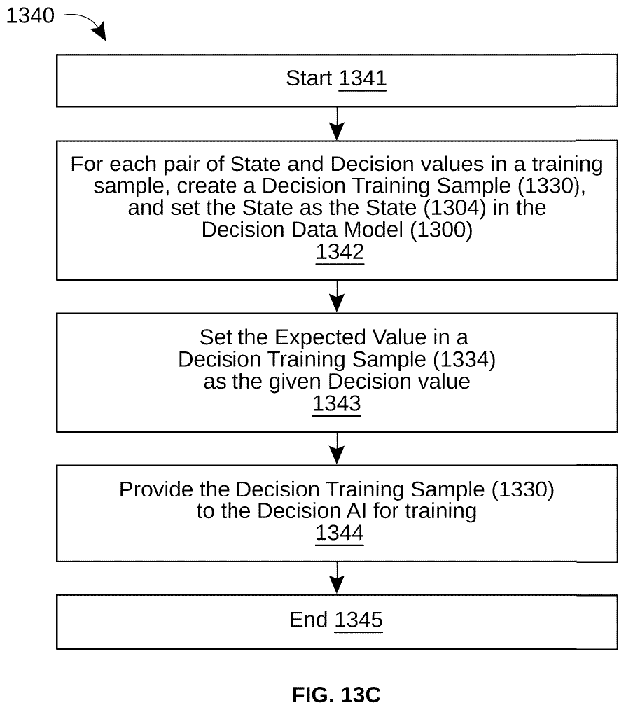

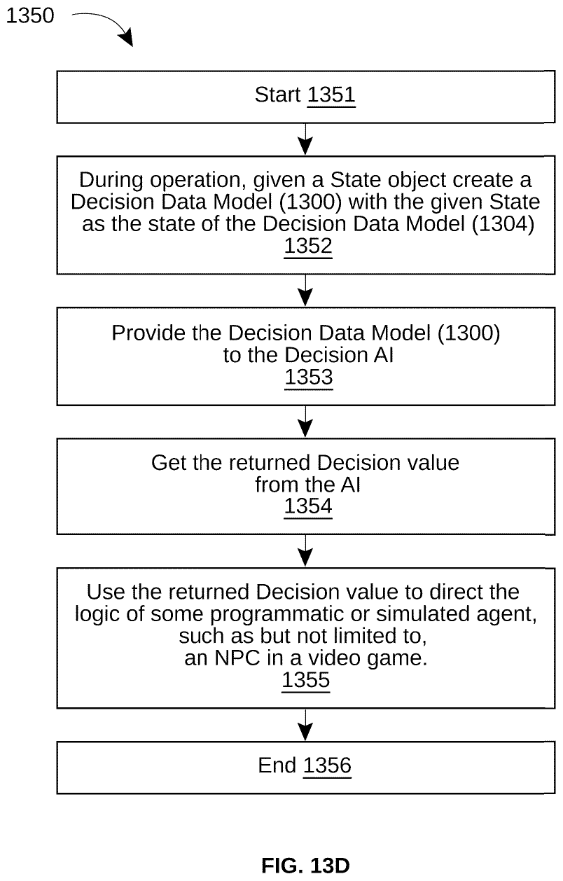

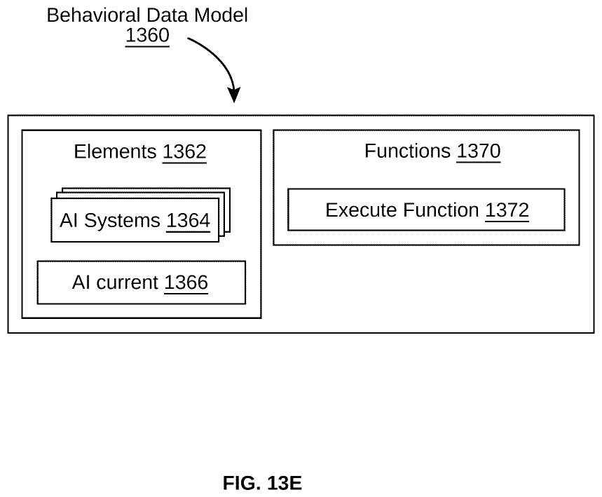

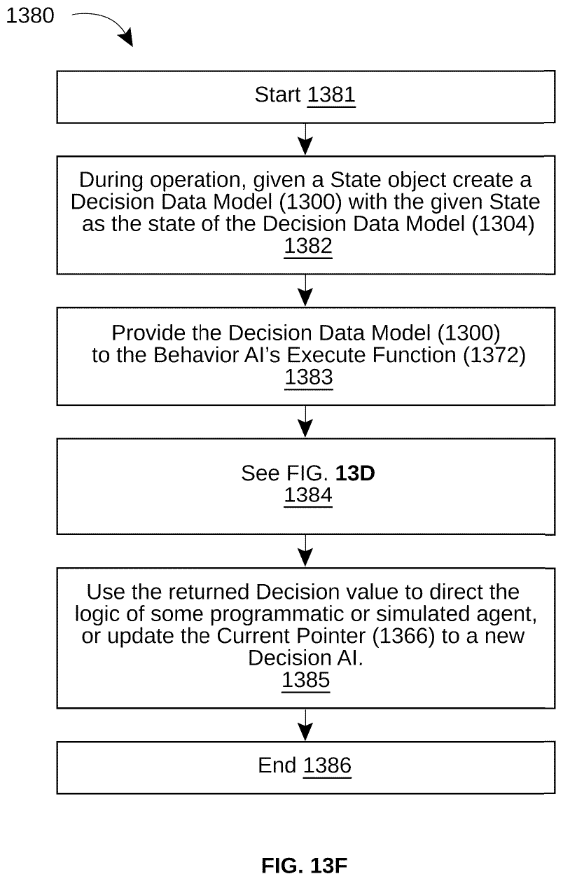

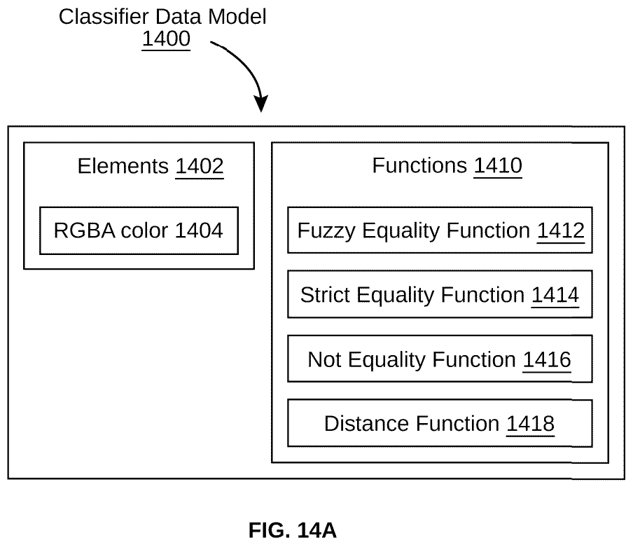

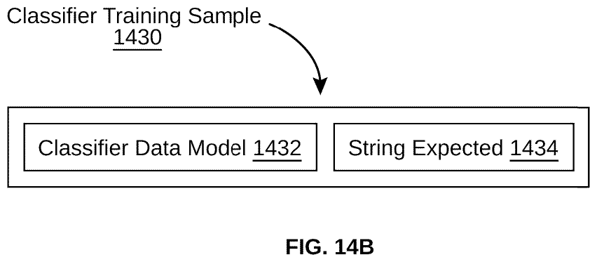

Referring to FIG. 13A, the architecture of a specific alteration of a Data Model (100), for use in dynamic decision making systems herein referred to as a Decision AI, denoted a Decision Data Model (1300) is illustrated. In this alteration the Elements (110) of the Decision Data Model (1302) are comprised of, but not limited to, a state object denoted as State (1304). A State object may be an arbitrary collection of one or more named values, but herein for the sake of this specific description will be considered as a collection of four integer values, denoted hunger, health, mood and energy. It will be obvious to anyone of ordinary skill in the Art, that obvious alterations may be made to the State object structure without requiring alteration of the details of the embodiment of the invention as described herein, and as such alterations fall within the Scope of the embodiment.

The Functions (120) of the Decision Data Model (1300) are also each defined according to arbitrary specifications meeting the criteria as set forth in the descriptions of the Data Model (100) but operating on the Elements of the Decision Data Model (1302). In this specific embodiment, the Functions (1310) are defined as follows. The Fuzzy Equality Function (1312) takes in two Decision Data Models (1300) and returns “true” if the values are equal or the sum of the distance between corresponding values is less than an arbitrary wildcard value. The Strict Equality Function (1314) takes in two Decision Data Models (1300) and returns true only if each of the corresponding values in both models are equal. The Not Equality Function (1316) returns the opposite or logical complement of the Fuzzy Equality Function (1312). The Distance Function (1318) returns a distance value as calculated by the following formula, given k is the number of values in a state object, and where the syntax w_i\hat{ }j indicates the i-th value in the j State object.

$$dist ( A , B ) = \sqrt{{\sum }_{i = 0}^{k} {( {w}_{i}^{B} - {w}_{i}^{A} )}^{2}}$$

Referring to FIG. 13B, the architecture of a specific alteration of a Training Sample (300) for use in dynamic decision-making systems, denoted a Decision Training Sample (1330) is illustrated. In this alteration the Data Model (310) of the Decision Training Sample (1332), is comprised of a Decision Data Model (1300). The Expected Value (320) of the Decision Training Sample (1334) is a Decision value, comprised of some arbitrary data which encodes an action in the given system in which the decision is employed to direct an agent, simulation or program behavior, to be associated with the given Decision Data Model (1300) as input (1332).

Referring to FIG. 13C, a flow-graph illustrating the general steps for training an AI (200) using a Decision Data Model (1300) and Decision Training Samples (1330), denoted as a Decision AI, is illustrated (1340). The process presumes a collection of data points comprised of, a State and Decision object pair, supplied as the input to the training process. For each pair of state and decision values, create a Training Sample and set the Decision Data Model (1332) State (1304) as the state value (1342). Set the Expected Value in the Decision Training Sample (1334) as the given decision value (1343). Provide the Decision Training Sample (1330) to the Decision AI for training (1344).

Referring to FIG. 13D, a flow-graph illustrating the general steps for employing a Decision AI using a Decision Data Model (1300) denoted as a Decision AI, is illustrated (1350). Given an input state object, create a Decision Data Model (1300) with the State in the Decision Data Model (1304) set to the provided state object value (1352). Then provide the Decision Data Model (1300) to the trained Decision AI (1353). The AI will return a decision object (1354) which may then be used by a system to execute some arbitrary logic, algorithm or behavior (1355). By employing this system, an NPC character or software system agent may be taught, from data, such as that created by a human operator, a method of behavior.

Additionally, a Decision AI may be considered analogous to a State Machine found in a Finite State Automata, whereby a higher-order object, herein referred to as a Behavior AI, encapsulates and employs arbitrary logic to transition between distinct Decision AI, is analogous to a Finite State Automata, for the sake of creating more sophisticated programmable agent behaviors. Optionally, a Behavior AI may be employed to extend the dynamic nature of a Decision AI, by training a plurality of Decision Als and programmatically or manually inserting them within a Behavior AI in some arbitrary manner.

Referring to FIG. 13E, the architecture of a Behavior AI (1360) is illustrated. A Behavior AI (1360) is comprised of at least, but not limited to, a plurality of Decision AI, denoted as AI Systems (1364), a software pointer or reference to a specific Decision AI within the collection of Decision AI Systems (1364), denoted as Current Reference (1366), and an arbitrary function, denoted as Execute Function (1372) which invokes the operational process of the Decision AI (1350) associated with the Current Reference (1366) value and may, in some defined cases, employ additional logic in conjunction with a returned Decision object to update the Current Reference (1366) in a manner analogous to a State Transition Function.

Referring to FIG. 13F, a flow-graph illustrating the general steps for the operation of a Behavior AI is shown (1380). Given an input state object, create a Decision Data Model (1300) with the State in the Decision Data Model (1304) set to the provided state object value (1382). Then provide the Decision Data Model (1300) to the Execute Function (1372) (1383). The Execute Function (1372) passes the Decision Data Model to the Decision AI referenced by the Current pointer (1366), initiating the Decision AI usage flow (1350) (1384). Upon the completion of the Decision AI operation, a Decision object is returned, which may be employed for arbitrary logic to drive some programmatic logic or simulated agent, or to initiate a change in the Current Reference (1366) to reference a different Decision AI within the plurality of AI Systems (1364) in the Behavior AI (1360) in a manner analogous to a State Transition Function (1385). The system then completes (1386). This method of operation may be employed at regular programmatic intervals to create highly dynamic software agents for use in video games, or other software applications and simulated environments.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. An adaptive artificial intelligence system for data model processing, comprising:
a data input module configured to receive raw data; a preprocessing module operatively coupled to the data input module and configured to preprocess the raw data to generate preprocessed data; a model training module operatively coupled to the preprocessing module and configured to train a model using the preprocessed data, wherein the model training module comprises an adaptive learning engine configured to adjust training parameters based on performance metrics; an image restoration module operatively coupled to the model training module and configured to apply the trained data model to restore image data; and a final product generation module operatively coupled to the image restoration module and configured to produce a final product based on the restored image data.

2. The system of claim 1 wherein the data model comprises a plurality of elements with each element comprising an identifier and value of arbitrary data types, the data model further comprising a plurality of functions, with the plurality of functions comprising a fuzzy equality function, a strict equality function, a not equality function and a distance function.

3. The system of claim 2 wherein the AI system comprises an associative container with the associative container comprising a second data model with the second data model in communication with a weighted table and the AI system further comprising a selection function and a collapse function.

4. The system of claim 3 wherein the data input module is further configured to accept input from a training sample the training sample comprising a third data model the third data model in communication with an expected value function.

5. The system of claim 4 wherein the system further comprises a computer, the computer comprising a processor, non volatile computer readable media, non volatile memory and a database of functions, the database of functions.
